(19) United States
(12) Patent Application Publication
(10) Pub. No.: US 2023/0208564 A1
(43) Pub. Date: Jun. 29, 2023

(54) HARQ TYPE CONFIGURATION FOR SIDELINK AND DOWNLINK COMMUNICATIONS

(71) Applicant: QUALCOMM Incorporated, San Diego, CA (US)

(72) Inventors: Ahmed Elshafie, San Diego, CA (US); Wei Yang, San Diego, CA (US); Yi Huang, San Diego, CA (US); Seyedkianoush Hosseini, San Diego, CA (US)

(21) Appl. No.: 17/565,122

(22) Filed: Dec. 29, 2021

(51) Int. Cl. H04L 1/18; H04W 72/04

(52) U.S. Cl. CPC H04L 1/1854; H04W 72/0406

(57) ABSTRACT

Methods, systems, and devices for wireless communications are described. In some examples, a receiving UE may receive an indication of a feedback mode for a set of sidelink or downlink transmissions, and the UE may operate in the indicated feedback mode for the set of sidelink or downlink transmissions. In some examples, the operating modes may include hybrid automatic repeat request (HARQ) feedback, negative acknowledgment only feedback, acknowledgement only feedback, or no feedback. In some examples, a default feedback mode may be configured, and the receiving UE may receive an indication to use a different feedback mode for a given set of sidelink or downlink transmissions. The receiving UE may revert to the default feedback mode after the set of sidelink or downlink transmissions. In some examples, different feedback modes may be associated with different sets of resource pools, semi-persistent scheduling indices, component carriers, or bandwidth parts.

### FIELD OF TECHNOLOGY

The following relates to wireless communications, including hybrid automatic repeat request type configuration for sidelink and downlink communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support hybrid automatic repeat request (HARQ) type configuration for sidelink and downlink communications. Generally, the described techniques provide for signaling feedback modes for downlink and sidelink transmissions operating in the signaled feedback mode. In some examples, a transmitting user equipment (UE) may indicate a feedback mode to a receiving UE for a set of sidelink transmissions, and the receiving UE may operate in the indicated feedback mode for the set of sidelink transmissions. In some examples, the operating modes may include HARQ feedback, negative acknowledgment (NACK) only feedback, acknowledgement (ACK) only feedback, or no feedback. In some examples, a default feedback mode may be configured, and the transmitting UE may indicate to use a different feedback mode for a given set of sidelink transmissions. The receiving UE may revert to the default feedback mode after the set of sidelink transmissions. In some examples, different feedback modes may be associated with different sets of resource pools.

In some examples, a base station may indicate a feedback mode to a UE for a set of downlink transmissions, and the UE may operate in the indicated feedback mode for the set of downlink transmissions. In some examples, a default feedback mode may be configured, and the base station may indicate to use a different feedback mode for a given set of downlink transmissions. The UE may revert to the default feedback mode after the set of downlink transmissions. In some examples, different feedback modes may be associated with different sets of semi-persistent scheduling indices, component carriers, or bandwidth parts.

A method for wireless communications at a first user equipment (UE) is described. The method may include receiving control signaling indicating a feedback mode for a set of sidelink transmissions, where the feedback mode is independent of a cast type of the set of sidelink transmissions, receiving, from a second UE, the set of sidelink transmissions, and operating in the feedback mode for the set of sidelink transmissions in accordance with the control signaling.

An apparatus for wireless communications at a first UE is described. The apparatus may include a processor, memory coupled with the processor, and instructions stored in the memory. The instructions may be executable by the processor to cause the apparatus to receive control signaling indicating a feedback mode for a set of sidelink transmissions, where the feedback mode is independent of a cast type of the set of sidelink transmissions, receive, from a second UE, the set of sidelink transmissions, and operate in the feedback mode for the set of sidelink transmissions in accordance with the control signaling.

Another apparatus for wireless communications at a first UE is described. The apparatus may include means for receiving control signaling indicating a feedback mode for a set of sidelink transmissions, where the feedback mode is independent of a cast type of the set of sidelink transmissions, means for receiving, from a second UE, the set of sidelink transmissions, and means for operating in the feedback mode for the set of sidelink transmissions in accordance with the control signaling.

A non-transitory computer-readable medium storing code for wireless communications at a first UE is described. The code may include instructions executable by a processor to receive control signaling indicating a feedback mode for a set of sidelink transmissions, where the feedback mode is independent of a cast type of the set of sidelink transmissions, receive, from a second UE, the set of sidelink transmissions, and operate in the feedback mode for the set of sidelink transmissions in accordance with the control signaling.

In some examples of the method, apparatuses, and non-transitory computer-readable medium described herein, operating in the feedback mode may include operations, features, means, or instructions for operating in a HARQ mode, an ACK only mode, a NACK only mode, or a no feedback mode.

Some examples of the method, apparatuses, and non-transitory computer-readable medium described herein may further include operations, features, means, or instructions for receiving the control signaling via a radio resource control message or a medium access control (MAC) control element, where the set of sidelink transmissions may be associated with a window of time.

Some examples of the method, apparatuses, and non-transitory computer-readable medium described herein may further include operations, features, means, or instructions for receiving the control signaling from a base station.

Some examples of the method, apparatuses, and non-transitory computer-readable medium described herein may further include operations, features, means, or instructions for receiving second control signaling indicating a default feedback mode and receiving third control signaling in a radio resource control message or a MAC control element indicating a second feedback mode associated with a window of time, and where receiving the control signaling indicating the feedback mode for the set of sidelink transmissions includes receiving the control signaling including a bit indicating that the first UE is to use the default feedback mode or the second feedback mode.

Some examples of the method, apparatuses, and non-transitory computer-readable medium described herein may further include operations, features, means, or instructions for receiving the second control signaling via a master information block via a physical broadcast channel.

Some examples of the method, apparatuses, and non-transitory computer-readable medium described herein may further include operations, features, means, or instructions for receiving second control signaling indicating a respective set of resource blocks associated with each feedback mode of a set of feedback modes.

Some examples of the method, apparatuses, and non-transitory computer-readable medium described herein may further include operations, features, means, or instructions for receiving the control signaling from the second UE via a sidelink control information message.

A method for wireless communications at a second UE is described. The method may include transmitting, to a first UE, control signaling indicating a feedback mode for a set of sidelink transmissions, where the feedback mode is independent of a cast type of the set of sidelink transmissions, transmitting, to the first UE, the set of sidelink transmissions, and operating in the feedback mode for the set of sidelink transmissions.

An apparatus for wireless communications at a second UE is described. The apparatus may include a processor, memory coupled with the processor, and instructions stored in the memory. The instructions may be executable by the processor to cause the apparatus to transmit, to a first UE, control signaling indicating a feedback mode for a set of sidelink transmissions, where the feedback mode is independent of a cast type of the set of sidelink transmissions, transmit, to the first UE, the set of sidelink transmissions, and operate in the feedback mode for the set of sidelink transmissions.

Another apparatus for wireless communications at a second UE is described. The apparatus may include means for transmitting, to a first UE, control signaling indicating a feedback mode for a set of sidelink transmissions, where the feedback mode is independent of a cast type of the set of sidelink transmissions, means for transmitting, to the first UE, the set of sidelink transmissions, and means for operating in the feedback mode for the set of sidelink transmissions.

A non-transitory computer-readable medium storing code for wireless communications at a second UE is described. The code may include instructions executable by a processor to transmit, to a first UE, control signaling indicating a feedback mode for a set of sidelink transmissions, where the feedback mode is independent of a cast type of the set of sidelink transmissions, transmit, to the first UE, the set of sidelink transmissions, and operate in the feedback mode for the set of sidelink transmissions.

Some examples of the method, apparatuses, and non-transitory computer-readable medium described herein may further include operations, features, means, or instructions for receiving, from a base station, second control signaling indicating the feedback mode for the set of sidelink transmissions, where the control signaling may be based on the second control signaling.

In some examples of the method, apparatuses, and non-transitory computer-readable medium described herein, operating in the feedback mode may include operations, features, means, or instructions for operating in a HARQ mode, an ACK only mode, a NACK only mode, or a no feedback mode.

Some examples of the method, apparatuses, and non-transitory computer-readable medium described herein may further include operations, features, means, or instructions for transmitting the control signaling via a radio resource control message or a MAC control element, where the set of sidelink transmissions associated with a window of time.

Some examples of the method, apparatuses, and non-transitory computer-readable medium described herein may further include operations, features, means, or instructions for transmitting, to the first UE, second control signaling indicating a default feedback mode and transmitting, to the first UE, third control signaling in a radio resource control message or a MAC control element indicating a second feedback mode associated with a window of time, and where transmitting the control signaling indicating the feedback mode for the set of sidelink transmissions includes transmitting the control signaling including a bit indicating that the first UE is to use the default feedback mode or the second feedback mode.

Some examples of the method, apparatuses, and non-transitory computer-readable medium described herein may further include operations, features, means, or instructions for transmitting the second control signaling via a master information block via a physical broadcast channel.

Some examples of the method, apparatuses, and non-transitory computer-readable medium described herein may further include operations, features, means, or instructions for receiving, from a base station, fourth control signaling indicating the default feedback mode.

Some examples of the method, apparatuses, and non-transitory computer-readable medium described herein may further include operations, features, means, or instructions for transmitting second control signaling indicating a respective set of resource blocks associated with each feedback mode of a set of feedback modes.

Some examples of the method, apparatuses, and non-transitory computer-readable medium described herein may further include operations, features, means, or instructions for receiving, from a base station, second control signaling indicating a set of feedback modes associated with each resource pool of a set of resource pools and identifying the feedback mode based on the set of feedback modes associated with a resource pool associated with the set of sidelink transmissions.

Some examples of the method, apparatuses, and non-transitory computer-readable medium described herein may further include operations, features, means, or instructions for identifying the feedback mode may be based on the set of feedback modes associated with the resource pool associated with the set of sidelink transmissions based on a priority level or a quality of service target associated with the set of sidelink transmissions.

Some examples of the method, apparatuses, and non-transitory computer-readable medium described herein may further include operations, features, means, or instructions for transmitting the control signaling via a sidelink control information message.

A method for wireless communications at a UE is described. The method may include receiving, from a base station, control signaling indicating a feedback mode for a set of downlink transmissions, receiving, from the base station, the set of downlink transmissions, and operating in the feedback mode for the set of downlink transmissions in accordance with the control signaling.

An apparatus for wireless communications at a UE is described. The apparatus may include a processor, memory coupled with the processor, and instructions stored in the memory. The instructions may be executable by the processor to cause the apparatus to receive, from a base station, control signaling indicating a feedback mode for a set of downlink transmissions, receive, from the base station, the set of downlink transmissions, and operate in the feedback mode for the set of downlink transmissions in accordance with the control signaling.

Another apparatus for wireless communications at a UE is described. The apparatus may include means for receiving, from a base station, control signaling indicating a feedback mode for a set of downlink transmissions, means for receiving, from the base station, the set of downlink transmissions, and means for operating in the feedback mode for the set of downlink transmissions in accordance with the control signaling.

A non-transitory computer-readable medium storing code for wireless communications at a UE is described. The code may include instructions executable by a processor to receive, from a base station, control signaling indicating a feedback mode for a set of downlink transmissions, receive, from the base station, the set of downlink transmissions, and operate in the feedback mode for the set of downlink transmissions in accordance with the control signaling.

Some examples of the method, apparatuses, and non-transitory computer-readable medium described herein may further include operations, features, means, or instructions for receiving, from the base station, second control signaling indicating a default feedback mode and receiving third control signaling, from the base station, in a radio resource control message or a MAC control element indicating a second feedback mode associated with a window of time, and where receiving the control signaling indicating the feedback mode for the set of downlink transmissions includes receiving the control signaling including a bit indicating that the UE is to use the default feedback mode or the second feedback mode.

Some examples of the method, apparatuses, and non-transitory computer-readable medium described herein may further include operations, features, means, or instructions for receiving the control signaling via a downlink control information message and identifying the feedback mode based on a format of the downlink control information message, a payload of the downlink control information message, a search space associated with the downlink control information message, a control resource set associated with the downlink control information message, or a combination thereof.

Some examples of the method, apparatuses, and non-transitory computer-readable medium described herein may further include operations, features, means, or instructions for receiving, from the base station, second control signaling indicating a set of feedback modes associated with each semi-persistent scheduling index of a set of semi-persistent scheduling indices and identifying the feedback mode based on the set of feedback modes associated with a semi-persistent scheduling index associated with the set of downlink transmissions.

Some examples of the method, apparatuses, and non-transitory computer-readable medium described herein may further include operations, features, means, or instructions for receiving, from the base station, second control signaling indicating a set of feedback modes associated with each component carrier of a set of component carriers and identifying the feedback mode based on the set of feedback modes associated with a component carrier associated with the set of downlink transmissions.

Some examples of the method, apparatuses, and non-transitory computer-readable medium described herein may further include operations, features, means, or instructions for receiving, from the base station, second control signaling indicating a default feedback mode and operating in the default feedback mode for a second set of downlink transmissions after the set of downlink transmissions.

### BRIEF DESCRIPTION OF THE DRAWINGS

FIG. 1 illustrates an example of a wireless communications system that supports hybrid automatic repeat request (HARQ) type configuration for sidelink and downlink communications in accordance with aspects of the present disclosure.

FIG. 2 illustrates an example of a wireless communications system that supports HARQ type configuration for sidelink and downlink communications in accordance with aspects of the present disclosure.

FIG. 3 illustrates an example of a process flow that supports HARQ type configuration for sidelink and downlink communications in accordance with aspects of the present disclosure.

FIG. 4 illustrates an example of a process flow that supports HARQ type configuration for sidelink and downlink communications in accordance with aspects of the present disclosure.

FIGS. 5 and 6 show block diagrams of devices that support HARQ type configuration for sidelink and downlink communications in accordance with aspects of the present disclosure.

FIG. 7 shows a block diagram of a communications manager that supports HARQ type configuration for sidelink and downlink communications in accordance with aspects of the present disclosure.

FIG. 8 shows a diagram of a system including a device that supports HARQ type configuration for sidelink and downlink communications in accordance with aspects of the present disclosure.

FIGS. 9 through 16 show flowcharts illustrating methods that support HARQ type configuration for sidelink and downlink communications in accordance with aspects of the present disclosure.

### DETAILED DESCRIPTION

In some wireless communications system, a receiving device such as a user equipment (UE) may provide feedback to a transmitting device (e.g., a base station or a second UE) regarding whether a transmission was received and decoded successfully at the receiving device. In some examples, a receiving UE may provide full hybrid automatic repeat request (HARQ) feedback, acknowledgement (ACK) only feedback, negative ACK (NACK) only feedback, or HARQ-less feedback (e.g., no feedback). HARQ feedback may be associated with greater accuracy, but also may be associated with a greater resource overhead. For some types of transmissions, ACK only feedback, NACK only feedback, or no feedback may be used without a significant degradation in accuracy as compared to HARQ feedback. For example, some packets may expire or may be associated with stringent delay applications, and accordingly HARQ feedback may provide less benefit for such packets. As another example, some transmissions may be associated with high accuracy, and accordingly NACK only feedback may be used to minimize communications resources used for feedback.

In some examples, a transmitting UE may indicate a feedback mode to a receiving UE for a set of sidelink transmissions, and the receiving UE may operate in the indicated feedback mode for the set of sidelink transmissions. In some examples, the operating modes may include HARQ feedback, NACK only feedback, ACK only feedback, or no feedback. In some examples, a default feedback mode may be configured, and the transmitting UE may indicate to use a different feedback mode for a given set of sidelink transmissions. The receiving UE may revert to the default feedback mode after the set of sidelink transmissions. In some examples, different feedback modes may be associated with different sets of resource pools.

In some examples, a base station may indicate a feedback mode to a UE for a set of downlink transmissions, and the UE may operate in the indicated feedback mode for the set of downlink transmissions. In some examples, a default feedback mode may be configured, and the base station may indicate to use a different feedback mode for a given set of downlink transmissions. The UE may revert to the default feedback mode after the set of downlink transmissions. In some examples, different feedback modes may be associated with different sets of semi-persistent scheduling (SPS) indices, component carriers, or bandwidth parts.

Aspects of the disclosure are initially described in the context of wireless communications systems. Aspects of the disclosure are further illustrated by and described with reference to wireless communications systems and process flows. Aspects of the disclosure are further illustrated by and described with reference to apparatus diagrams, system diagrams, and flowcharts that relate to HARQ type configuration for sidelink and downlink communications.

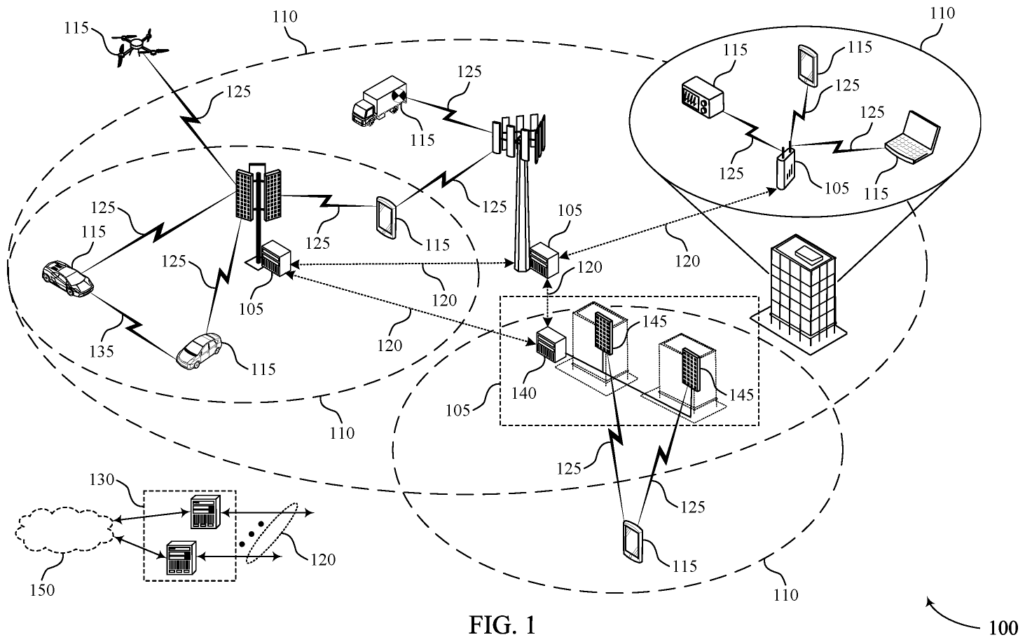

FIG. 1 illustrates an example of a wireless communications system 100 that supports HARQ type configuration for sidelink and downlink communications in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device, etc.), a camera, a gaming device, a navigation/positioning device (e.g., GNSS (global navigation satellite system) devices based on, for example, GPS (global positioning system), Beidou, GLONASS, or Galileo, or a terrestrial-based device, a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. HARQ feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, a receiving UE 115 may provide full HARQ feedback, ACK only feedback, NACK only feedback, or HARQ-less feedback (e.g., no feedback) to a transmitting device such as a base station 105 or a transmitting UE 115 (e.g., for sidelink communications). HARQ feedback may be associated with greater accuracy, but also may be associated with more resource overhead. For some types of transmissions, ACK only feedback, NACK only feedback, or no feedback may be used without a significant degradation in accuracy as compared to HARQ feedback. For example, some packets may expire or may be associated with stringent delay applications, and accordingly HARQ feedback may be associated with little benefit for such packets. As another example, some transmissions may be associated with high accuracy, and accordingly NACK only feedback may be used to minimize communications resources used for feedback.

In some examples, a transmitting UE 115 may indicate a feedback mode to a receiving UE 115 for a set of sidelink transmissions, and the receiving UE 115 may operate in the indicated feedback mode for the set of sidelink transmissions. In some examples, the operating modes may include HARQ feedback, NACK only feedback, ACK only feedback, or no feedback. In some examples, a default feedback mode may be configured, and the transmitting UE 115 may indicate to use a different feedback mode for a given set of sidelink transmissions. The receiving UE 115 may revert to the default feedback mode after the set of sidelink transmissions. In some examples, different feedback modes may be associated with different sets of resource pools.

In some examples, a base station 105 may indicate a feedback mode to a UE 115 for a set of downlink transmissions, and the UE 115 may operate in the indicated feedback mode for the set of downlink transmissions. In some examples, a default feedback mode may be configured, and the base station 105 may indicate to use a different feedback mode for a given set of downlink transmissions. The UE 115 may revert to the default feedback mode after the set of downlink transmissions. In some examples, different feedback modes may be associated with different sets of SPS indices, component carriers, or bandwidth parts.

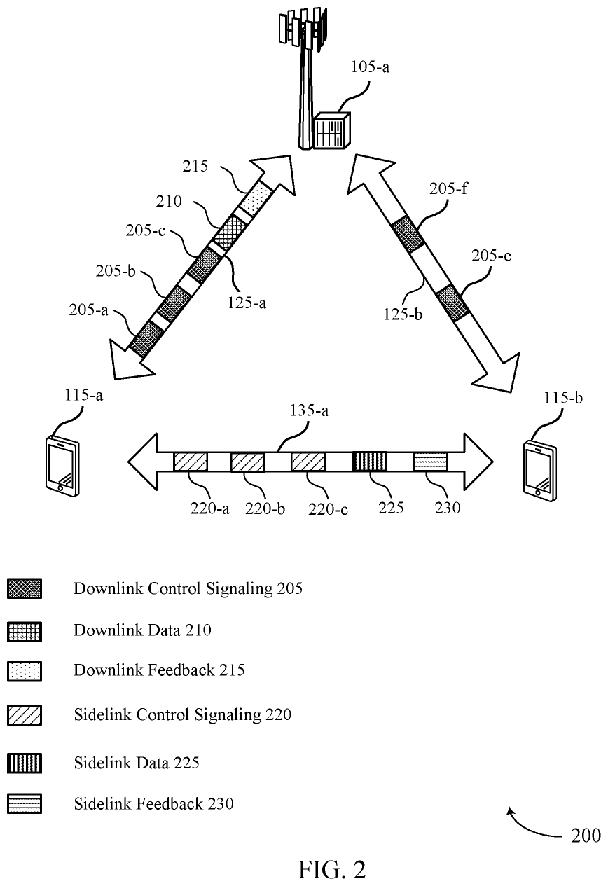

FIG. 2 illustrates an example of a wireless communications system 200 that supports HARQ type configuration for sidelink and downlink communications in accordance with aspects of the present disclosure. In some examples, the wireless communications system 200 may implement aspects of wireless communications system 100. The wireless communications system 200 may include UEs 115-a and 115-b, which may be examples of UEs 115 as described herein. The wireless communications system 200 may include a base stations 105-a, which may be an example of a base station 105 as described herein.

The first UE 115-a and the second UE 115-b may communicate with the base station 105-a using communication link 125-a and 125-b, respectively, which may be examples of an NR or LTE link between the first UE 115-a or the second UE 115-b, respectively, and the base station 105-a. The communication link 125-a and the communication link 125-b may include a bi-directional link that enables both uplink and downlink communication. For example, the first UE 115-a may transmit uplink signals, such as uplink control signals or uplink data signals, to the base station 105-a using the communication link 125-a and the base station 105-a may transmit downlink signals, such as downlink control signals or downlink data signals, to the first UE 115-a using the communication link 125-a. In some examples, the base station 105-a may communicate with the UE 115-a over the communication link 125-a and the UE 115-b over the communication link 125-b using directional communications techniques (e.g., beamforming techniques). For example, the base station 105-a may communicate with the UE 115-a and the UE 115-b via one or more beams.

The first UE 115-a may communicate with the second UE 115-b using a sidelink communication link 135-a. The sidelink communication link 135-a may include a bi-directional link that enables the UE 115-a to transmit signals to and receive signals from the UE 115-b. In some examples, the base station 105-a may configure resources for the sidelink communication link 135-a. In some examples, the UE 115-a may communicate with the UE 115-b over the sidelink communication link 135-a using directional communications techniques (e.g., beamforming techniques). For example, the UE 115-a may communicate with the UE 115-b via one or more beams. The sidelink communication link 135-a may support URLLC or internet of things applications or various quality of service and priorities applications.

In the wireless communications system 200, a receiving UE (e.g., UE 115-b for sidelink communications or UE 115-a for downlink communications) may receive an indication of a feedback mode for a set of sidelink or downlink transmissions, and the UE 115 may operate in the indicated feedback mode for the set of sidelink or downlink transmissions. In some examples, the operating modes may include HARQ feedback, NACK only feedback, ACK only feedback, or no feedback.

In some examples, the base station 105-a may schedule communications with the UE 115-a in accordance with an SPS configuration that may trigger multiple physical downlink shared channel (PDSCH) messages. In some examples, the base station 105-a may schedule one or more PDSCH messages via downlink control information (DCI). For an SPS configuration or DCI triggering multiple PDSCH messages, the base station 105-a link adaption, power control, and rate adaption may be associated with a target success rate for the multiple PDSCH messages. For example, for eMBB, the target success rate may be 90%, and for URLLC, the target success rate may be 90% for the first PDSCH transmission and 99.999% for the second PDSCH transmission. Given the high PDSCH success rate for URLLC and eMBB, for example, when operating in a HARQ mode, the UE 115-a may feedback an ACK to the base station 105-a for most of the transmissions. Accordingly, a UE 115-a may save power and reduce interference to other UEs 115 by feeding back a NACK only (e.g., skipping ACK feedback). In a NACK only feedback mode, the base station 105-a may assume that a PDSCH was successfully received and decoded if the base station 105-a does not receive a NACK. If the uplink channel from the UE 115-a to the base station is broken or not working (e.g., due to deep fading, severe interference, or hard blocking in FR2), however, the base station 105-a may not receive a NACK transmitted by the UE 115-a. Thus, a base station 105-a may assume the UE 115-a successfully received a PDSCH transmission that the UE 115-a did not successfully receive.

For sparse or sporadic traffic per SPS configurations, an ACK only feedback mode may not be efficient as the UE 115-a may send a dummy NACK for skipped SPS PDSCH occasions. Therefore, multiple skipped SPS PDSCH occasions may increase payload size if the UE 115-a is operating in an ACK only feedback mode.

For some expired packets or for packets with stringent delay applications, if feedback arrives late, there may be little or no benefit for ACK/NACK feedback. Therefore for some scenarios, HARQ-less or no feedback may be the most efficient use of resources.

In some examples, the UE 115-a may unicast signals to the UE 115-b. In some examples, unicasting may be associated with HARQ feedback. In some examples, the UE 115-a may groupcast signals to a group of UEs 115. In some examples, groupcast may be associated with HARQ feedback, ACK only feedback, or NACK only feedback. The UE 115-a may indicate which feedback mode to use using sidelink control information (SCI) format 2A. In some examples, the UE 115-a may broadcast signals. In some examples, broadcast may be associated with a no feedback mode.

SCI format 2A may be used for decoding of physical sidelink shared channel (PSSCH). SCI 2A may include: 4 bits indicating a HARQ process number, 1 bit indicating a new data indicator, 2 bits indicating a redundancy version, 8 bits indicating a source identifier, 16 bits indicating a destination identifier, 1 bit indicating whether HARQ is enabled or disabled, 2 bits indicating a cast type, and 1 bit indicating a channel state information (CSI) request.

In some examples, per resource pool, unicast and groupcast may be configured with a no feedback mode if the physical sidelink feedback channel (PSFCH) periodicity is set to zero, which may disable HARQ feedback for all UEs 115 using the resource pool. In some examples, using HARQ feedback is enabled or disabled via a bit in SCI-2A for unicast and groupcast. If enabled (e.g., the HARQ feedback enable bit is set to “1”), the groupcast may be NACK only or regular HARQ feedback, which may be indicated using cast type bits in SCI (e.g., “00” may indicate broadcast, “01” may indicate groupcast with HARQ feedback, “10” may indicate unicast, and “11” may indicate groupcast with NACK only feedback.

Some example UEs 115 may not take traffic priorities, channel conditions, or delay targets into account when selecting a feedback mode, which may result in lost packets or inefficient feedback operations. For example, if the feedback channel from the UE 115-b to the UE 115-a is broken (e.g., due to deep fading, severe interference, or hard blocking in FR2), the UE 115-a may not receive a NACK transmitted by the UE 115-b. The UE 115-a may accordingly assume in a NACK only mode that the UE 115-b successfully received the corresponding PSSCH transmission, which may be challenging for transmissions with stringent delay applications or for high priority transmissions. In some examples, if the traffic is low priority or not associated with stringent delay applications, then no feedback may be used to reduce traffic and interference. In some examples, if the traffic is low priority or not associated with stringent delay applications, then NACK only feedback may be used to retransmit the traffic priority at a later occasion. In some examples, for stringent delay applications or for high priority transmissions, no feedback may be most efficient, (e.g., given that HARQ feedback time may be 2 slots).

In some examples, in the case of sidelink transmissions scheduled according to configured grants, the base station 105-a may transmit control signaling 205-a (e.g., DCI) to the transmitting UE 115-a indicating a feedback type (e.g., HARQ, ACK only, NACK only, or no feedback) for a set of sidelink transmissions 225 (e.g., one or more PSSCH transmissions), where the feedback type may be independent of a cast type of the set of sidelink transmissions. The receiving UE 115-b may not receive an indication of the configured grant process (e.g., from the perspective of the receiving UE 115-b, configured grant transmissions and non-configured grant transmissions may be the same and the receiving UE 115-b responds the same way to both). The UE 115-a may transmit control signaling 220-a (e.g., via SCI-2) including an indication of the feedback type to the UE 115-b for the set of sidelink transmissions 225. The UE 115-b may provide feedback 230 (or the UE 115-b may not provide feedback 230 if the indicated feedback mode is a no feedback mode, or the UE 115-b may not transmit feedback if operating in a NACK only mode and the sidelink transmissions 225 were successfully received, or the UE 115-b may not transmit feedback if operating in an ACK only mode and the sidelink transmissions 225 were not successfully received) for the set of sidelink transmissions 225 according to the indicated feedback mode.

In some examples, if the feedback type is the same for all transmissions within a given window of time, the transmitting UE 115-a may configure the receiving UE 115-b using a PC5-RRC or MAC control element (MAC-CE) message (e.g., the control signaling 220-a may be transmitted using a PC5-RRC or MAC-CE message).

In some examples, the base station 105-a may transmit control signaling 205-b (e.g., via an RRC or MAC-CE message) to the UE 115-a indicating a default feedback type. In some examples, the receiving UE 115-b may receive the indication of the default feedback type from the base station 105-a via control signaling 205-e. In some examples, the UE 115-a may transmit control signaling 220-b indicating the default feedback type. In some examples, the UE 115-a may transmit the control signaling 220-b indicating the default feedback type via a master information block (MIB) sent via a physical sidelink broadcast channel. In some examples, the UE 115-a may transmit a recommendation of a feedback type to the base station 105-a, and the base station 105-a may transmit the control signaling 205-b configuring the default feedback type. In some examples, the transmitting UE 115-a may select the default feedback type.

In some examples. the feedback mode may be given a value that may be added to a PSFCH selection (e.g., in SCI) such that an ACK only mode may be separated in the frequency domain (e.g., on the resource block level) from NACK only mode, which may be separated in the frequency domain from the HARQ mode. In some examples, the feedback modes may be given values added to the PSFCH selection that are associated with different cyclic shifts. Adding such values to the PSFCH selection may increase the reliability of the PSFCH. For example, in MU-MIMO cases where one transmitting UE 115-a may transmit signals to two different receiving UEs 115, the feedback on the PSFCH from the UEs 115 may collide on the same resource block (when the transmission is not groupcast). By separating the UEs 115 based on the type of reporting, collisions may be avoided.

In some examples, the base station 105-a may transmit control signaling 205-c configuring respective resource pools to be associated with given feedback modes. For example, the base station 105-a may configure each resource pool of a set of resource pools to be associated with ACK only, NACK only, HARQ, or no feedback. The base station 105-a may further define or parameterize the association per priority or quality of service target. If more than one type of feedback is associated with a given resource pool, the UE 115-a may select a feedback mode from the set of feedback modes associated with the resource pool for a sidelink transmissions 220 and may indicate in the control signaling 220-a the selected feedback mode.

In some examples, the receiving UE 115-b may also receive the indication of the association of the feedback modes with given resource pools, for example via control signaling 205-f In some examples, the transmitting UE 115-a may transmit control signaling 220-c indicating the association of the feedback modes with given resource pools. The transmitting UE 115-b may indicate the type of feedback mode in the control signaling 220-a based on the available resource pool for a given sidelink transmission 225.

In some examples, the base station 105-a may transmit control signaling 205-a indicating for the UE 115-a to operate in a given feedback mode for a set of downlink transmissions 210 (e.g., one or more PDSCH transmissions). For example, the control signaling 205-a may be transmitted via an RRC or MAC-CE message indicating for the UE 115-a to operate in the given feedback mode. In some examples, the control signaling 205-a may be a DCI message, and the given feedback mode may be indicated by the DCI format, a DCI CORESET, a DCI search space, or bits in the DCI payload (e.g., 2 bits may indicate whether the feedback mode is a HARQ mode, an ACK only mode, a NACK only mode, or a no feedback mode). The UE 115-a may operate in the indicated feedback mode for the set of downlink transmissions 210. For example, the UE 115-a may transmit feedback 215 to the base station 105-a for the set of downlink transmissions (or the UE 115-a may not transmit feedback 215 if the feedback mode is a no feedback mode, or the UE 115-a may not transmit feedback if operating in a NACK only mode and the downlink transmissions 210 were successfully received, or the UE 115-a may not transmit feedback if operating in an ACK only mode and the downlink transmissions 210 were not successfully received).

In some examples, the base station 105-a may transmit control signaling 205-b indicating a default feedback mode. In some examples, the default feedback mode may be defined or parameterized per priority or quality of service target associated with downlink transmissions 210. In some examples, the control signaling 205-a may indicate whether to use the default mode or a different feedback mode for the set of downlink transmissions 210. In some examples, the control signaling 205-b indicating the default feedback mode may be transmitted in a MIB in a physical broadcast channel. In some examples, the base station 105-a may transmit control signaling 205-c indicating to fall back to the default feedback mode after a set of downlink transmissions 210 (e.g., via one bit in DCI).

In some examples, the base station 105-a may transmit control signaling 205-b indicating a feedback mode associated with each SPS index of a set of SPS indices, and the UE 115-a may identify a feedback mode for a given downlink transmission 210 based on the SPS index associated with the downlink transmission 210 (e.g., where the control signaling 205-a may indicate the SPS index associated with the downlink transmission 210).

In some examples, the base station 105-a may transmit control signaling 205-b indicating a feedback mode associated with each component carrier of a set of component carriers, and the UE 115-a may identify a feedback mode for a given downlink transmission 210 based on the component carrier associated with the downlink transmission 210 (e.g., where the control signaling 205-a may indicate the component carrier associated with the downlink transmission 210).

In some examples, the base station 105-a may transmit control signaling 205-b indicating a feedback mode associated with each bandwidth part of a set of bandwidth parts, and the UE 115-a may identify a feedback mode for a given downlink transmission 210 based on the bandwidth part associated with the downlink transmission 210 (e.g., where the control signaling 205-a may indicate the bandwidth part associated with the downlink transmission 210).

In some examples, the control signaling 205-a (e.g., DCI) may indicate a feedback mode for a set of downlink transmissions 210. The UE 115-a may operate in the default feedback mode after the set of downlink transmissions 210 (e.g., for a subsequent set of downlink transmissions). For example, after a set of slots or grants configured by the control signaling 205-a, the feedback mode configured by the control signaling 205-a may be turned off and the UE 115-a may revert to the default feedback mode for all downlink communications or for each SPS configuration or for each application (e.g., based on priority).

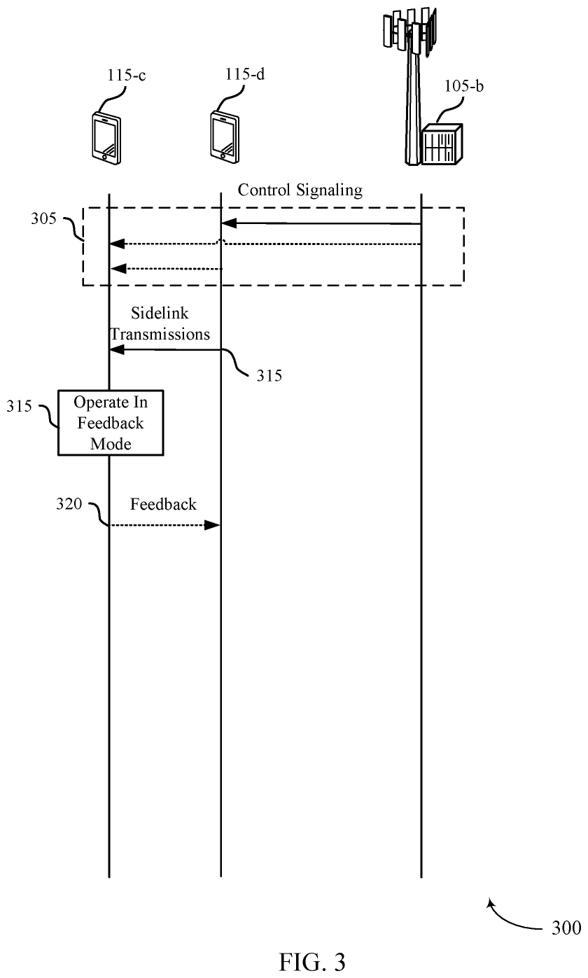

FIG. 3 illustrates an example of a process flow 300 that supports HARQ type configuration for sidelink and downlink communications in accordance with aspects of the present disclosure. In some examples, the process flow 300 may be implemented by or may implement aspects of the wireless communications system 100 or 200. The process flow 300 may include a UE 115-c and a UE 115-d, which may be examples of a UE 115 as described herein. The process flow 300 may also include a base station 105-b, which may be an example of the base station 105 as described herein. In the following description of the process flow 300, the operations between the base station 105-b, the UE 115-c, and the UE 115-d may be transmitted in a different order than the example order shown, or the operations performed by the base station 105-b, the UE 115-c, and the UE 115-d may be performed in different orders or at different times. Some operations may also be omitted from the process flow 300, and other operations may be added to the process flow 300.

At 305, the UE 115-c may receive control signaling indicating feedback mode for a set of sidelink transmissions, where the feedback mode is independent of a cast type of the set of sidelink transmissions. In some examples, the feedback mode may be one of a HARQ mode, an ACK only mode, a NACK only mode, or a no feedback mode.

In some examples, the UE 115-c may receive the control signaling from the UE 115-d. For example, the UE 115-c may receive the control signaling via an SCI message, an RRC message, or a MAC-CE message. In some examples, the UE 115-d may receive an indication of the feedback mode for the set of sidelink transmissions from the base station 105-b, and the UE 115-d may transmit (e.g., forward) the indication of the feedback mode for the set of sidelink transmission to the UE 115-c.

In some examples, the UE 115-c may receive the control signaling from the base station 105-b. For example, the UE 115-c may receive the control signaling via a DCI message, an RRC message, or a MAC-CE message.

In some examples, the UE 115-c may receive the control signaling via an RRC message or a MAC-CE message, and the set of sidelink transmissions may be associated with a window of time.

At 310, the UE 115-c may receive, from the UE 115-d, a set of sidelink transmissions.

At 315, the UE 115-c may operate in the feedback mode indicated in the control signaling received at 305.

At 320, if feedback mode is a HARQ mode, the UE 115-c may transmit, to the UE 115-d, feedback for the set of sidelink transmissions. If the feedback mode is an ACK only mode, the UE 115-c may transmit, to the UE 115-d, ACK feedback for the sidelink transmissions of the set of sidelink transmissions that were successfully received. If the feedback mode is a NACK only mode, the UE 115-c may transmit, to the UE 115-d, NACK feedback for the sidelink transmissions of the set of sidelink transmissions that were not successfully received. If the feedback mode is a no feedback mode, the UE 115-c may not transmit feedback for the set of sidelink transmissions.

In some examples, prior to receiving the control signaling at 305, the UE 115-c may receive second control signaling indicating a default feedback mode for downlink transmissions and third control signaling via an RRC message or a MAC-CE message indicating a second feedback mode associated with a window of time. The control signaling may include a bit indicating that the UE 115-c is to use the default feedback mode or the second feedback mode. In some examples, the UE 115-c may receive the second control signaling via a MIB or via a physical broadcast channel. In some examples, the UE 115-d may receive an indication of the default feedback mode from the base station 105-b, and the UE 115-d may transmit an indication of the default feedback mode to the UE 115-c.

In some examples, prior to receiving the control signaling at 305, the UE 115-c may receive second control signaling indicating a respective set of resource blocks associated with each feedback mode of a set of feedback modes. In some examples, the UE 115-d may transmit the second control signaling indicating a respective set of resource blocks associated with each feedback mode of a set of feedback modes.

In some examples, the UE 115-d may receive, from the base station 105-b, second control signaling indicating set of feedback modes associated with each resource pool of a set of resource pools. The UE 115-d may identify the feedback mode based on the set of feedback modes associated with a resource pool associated with the set of sidelink transmissions, and the UE 115-d may transmit the control signaling to the UE 115-c indicating the feedback mode for the set of sidelink transmissions. In some examples, the UE 115-d may identify the feedback mode based on the set of feedback modes associated with the resource pool associated with the set of sidelink transmissions based on a priority level or a quality of service target associated with the set of sidelink transmissions.

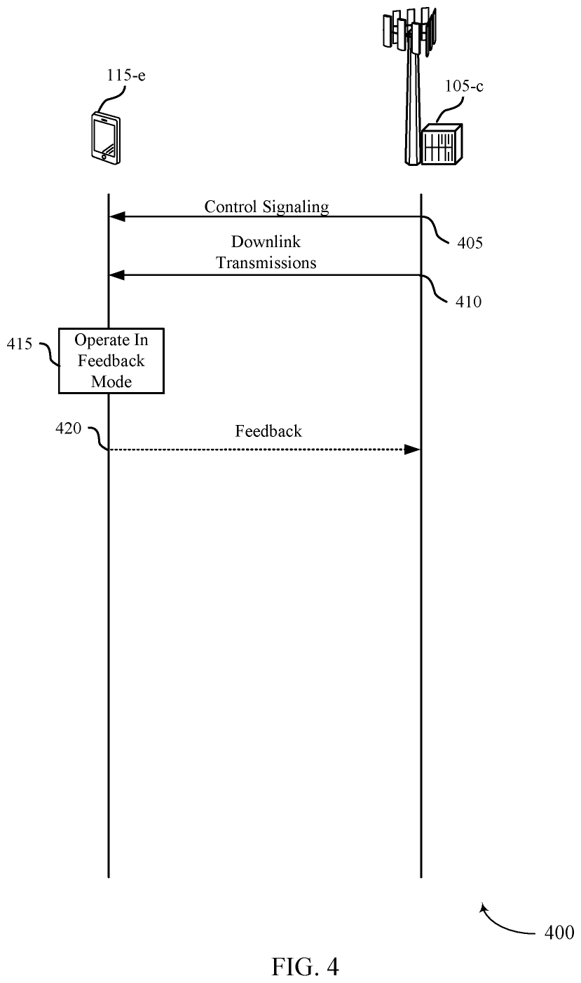

FIG. 4 illustrates an example of a process flow 400 that supports HARQ type configuration for sidelink and downlink communications in accordance with aspects of the present disclosure. In some examples, the process flow 400 may be implemented by or may implement aspects of the wireless communications system 100 or 200. The process flow 400 may include a UE 115-e, which may be an example of a UE 115 as described herein. The process flow 400 may also include a base station 105-c, which may be an example of the base station 105 as described herein. In the following description of the process flow 400, the operations between the base station 105-c and the UE 115-e may be transmitted in a different order than the example order shown, or the operations performed by the base station 105-c and the UE 115-e may be performed in different orders or at different times. Some operations may also be omitted from the process flow 400, and other operations may be added to the process flow 400.

At 405, the UE 115-e may receive, from the base station 105-c, control signaling indicating a feedback mode for a set of downlink transmissions. In some examples, the control signaling may be received via a MAC-CE signal or an RRC signal. In some examples, the feedback mode may be one of a HARQ mode, an ACK only mode, a NACK only mode, or a no feedback mode. In some examples, the UE 115-e may receive the control signaling via a DCI message, and the UE 115-e may identify the feedback mode based on a format of the DCI message, a payload of the DCI message, a search space associated with the DCI message, a CORESET associated with the DCI message, or a combination thereof.

At 410, the UE 115-e may receive, from the base station 105-c, a set of downlink transmissions.

At 415, the UE 115-e may operate in the feedback mode indicated in the control signaling received at 405.

At 420, if feedback mode is a HARQ mode, the UE 115-e may transmit, to the base station 105-c, feedback for the set of downlink transmissions. If the feedback mode is an ACK only mode, the UE 115-e may transmit, to the base station 105-c, ACK feedback for the downlink transmissions of the set of downlink transmissions that were successfully received. If the feedback mode is a NACK only mode, the UE 115-e may transmit, to the base station 105-c, NACK feedback for the downlink transmissions of the set of downlink transmissions that were not successfully received. If the feedback mode is a no feedback mode, the UE 115-e may not transmit feedback for the set of downlink transmissions.

In some examples, prior to receiving the control signaling at 405, the UE 115-e may receive, from the base station 105-c, second control signaling indicating a default feedback mode for downlink transmissions and third control signaling via an RRC message or a MAC-CE message indicating a second feedback mode associated with a window of time. The control signaling may include a bit indicating that the UE 115-e is to use the default feedback mode or the second feedback mode.

In some examples, prior to receiving the control signaling at 405, the UE 115-e may receive, from the base station 105-c, second control signaling indicating a set of feedback modes associated with each SPS index of a set of SPS indices, and the UE 115-e may identify the feedback mode based on the set of feedback modes associated with an SPS index associated with the set of downlink transmissions. For examples, the control signaling received at 405 may indicate an SPS index associated with the set of downlink transmissions.

In some examples, prior to receiving the control signaling at 405, the UE 115-e may receive, from the base station 105-c, second control signaling indicating a set of feedback modes associated with each component carrier of a set of component carriers, and the UE 115-e may identify the feedback mode based on the set of feedback modes associated with a component carrier associated with the set of downlink transmissions. For examples, the control signaling received at 405 may indicate a component carrier associated with the set of downlink transmissions.

In some examples, prior to receiving the control signaling at 405, the UE 115-e may receive, from the base station 105-c, second control signaling indicating a default feedback mode, and after the set of downlink transmissions, the UE 115-e may operate in the default feedback mode for a second set of downlink transmissions.

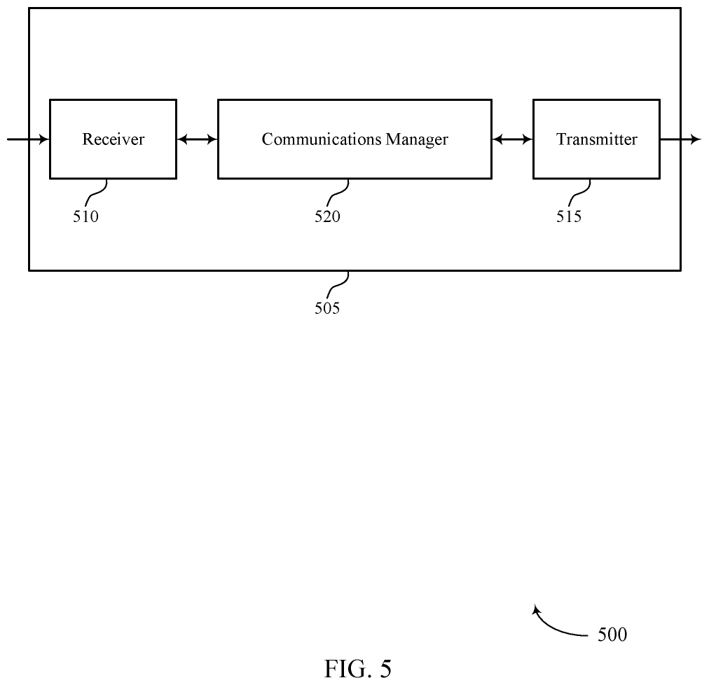

FIG. 5 shows a block diagram 500 of a device 505 that supports HARQ type configuration for sidelink and downlink communications in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to HARQ type configuration for sidelink and downlink communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to HARQ type configuration for sidelink and downlink communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of HARQ type configuration for sidelink and downlink communications as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software) executed by a processor. If implemented in code executed by a processor, the functions of the communications manager 520, the receiver 510, the transmitter 515, or various combinations or components thereof may be performed by a general-purpose processor, a DSP, a central processing unit (CPU), a graphics processing unit (GPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a first UE in accordance with examples as disclosed herein. For example, the communications manager 520 may be configured as or otherwise support a means for receiving control signaling indicating a feedback mode for a set of sidelink transmissions, where the feedback mode is independent of a cast type of the set of sidelink transmissions. The communications manager 520 may be configured as or otherwise support a means for receiving, from a second UE, the set of sidelink transmissions. The communications manager 520 may be configured as or otherwise support a means for operating in the feedback mode for the set of sidelink transmissions in accordance with the control signaling.

Additionally or alternatively, the communications manager 520 may support wireless communications at a second UE in accordance with examples as disclosed herein. For example, the communications manager 520 may be configured as or otherwise support a means for transmitting, to a first UE, control signaling indicating a feedback mode for a set of sidelink transmissions, where the feedback mode is independent of a cast type of the set of sidelink transmissions. The communications manager 520 may be configured as or otherwise support a means for transmitting, to the first UE, the set of sidelink transmissions. The communications manager 520 may be configured as or otherwise support a means for operating in the feedback mode for the set of sidelink transmissions.

Additionally or alternatively, the communications manager 520 may support wireless communications at a UE in accordance with examples as disclosed herein. For example, the communications manager 520 may be configured as or otherwise support a means for receiving, from a base station, control signaling indicating a feedback mode for a set of downlink transmissions. The communications manager 520 may be configured as or otherwise support a means for receiving, from the base station, the set of downlink transmissions. The communications manager 520 may be configured as or otherwise support a means for operating in the feedback mode for the set of downlink transmissions in accordance with the control signaling.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for reduced processing, reduced power consumption, and more efficient utilization of communication resources by facilitating selection of an efficient feedback mode for given sidelink or downlink transmissions.

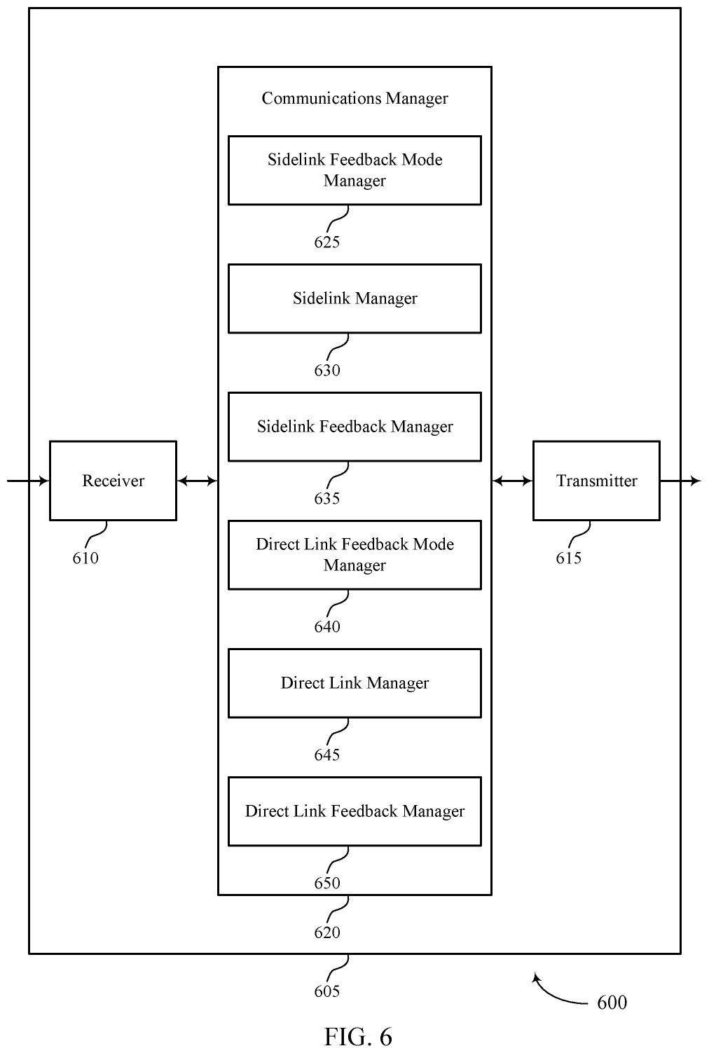

FIG. 6 shows a block diagram 600 of a device 605 that supports HARQ type configuration for sidelink and downlink communications in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to HARQ type configuration for sidelink and downlink communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to HARQ type configuration for sidelink and downlink communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of HARQ type configuration for sidelink and downlink communications as described herein. For example, the communications manager 620 may include a sidelink feedback mode manager 625, a sidelink manager 630, a sidelink feedback manager 635, a direct link feedback mode manager 640, a direct link manager 645, a direct link feedback manager 650, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a first UE in accordance with examples as disclosed herein. The sidelink feedback mode manager 625 may be configured as or otherwise support a means for receiving control signaling indicating a feedback mode for a set of sidelink transmissions, where the feedback mode is independent of a cast type of the set of sidelink transmissions. The sidelink manager 630 may be configured as or otherwise support a means for receiving, from a second UE, the set of sidelink transmissions. The sidelink feedback manager 635 may be configured as or otherwise support a means for operating in the feedback mode for the set of sidelink transmissions in accordance with the control signaling.

Additionally or alternatively, the communications manager 620 may support wireless communications at a second UE in accordance with examples as disclosed herein. The sidelink feedback mode manager 625 may be configured as or otherwise support a means for transmitting, to a first UE, control signaling indicating a feedback mode for a set of sidelink transmissions, where the feedback mode is independent of a cast type of the set of sidelink transmissions. The sidelink manager 630 may be configured as or otherwise support a means for transmitting, to the first UE, the set of sidelink transmissions. The sidelink feedback manager 635 may be configured as or otherwise support a means for operating in the feedback mode for the set of sidelink transmissions.

Additionally or alternatively, the communications manager 620 may support wireless communications at a UE in accordance with examples as disclosed herein. The direct link feedback mode manager 640 may be configured as or otherwise support a means for receiving, from a base station, control signaling indicating a feedback mode for a set of downlink transmissions. The direct link manager 645 may be configured as or otherwise support a means for receiving, from the base station, the set of downlink transmissions. The direct link feedback manager 650 may be configured as or otherwise support a means for operating in the feedback mode for the set of downlink transmissions in accordance with the control signaling.

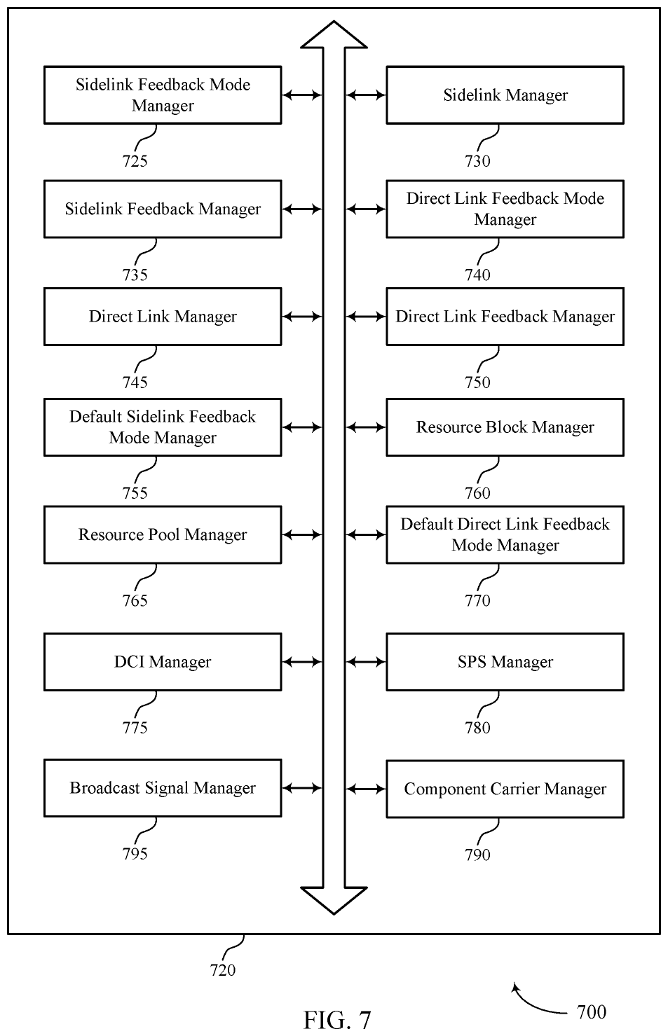

FIG. 7 shows a block diagram 700 of a communications manager 720 that supports HARQ type configuration for sidelink and downlink communications in accordance with aspects of the present disclosure. The communications manager 720 may be an example of aspects of a communications manager 520, a communications manager 620, or both, as described herein. The communications manager 720, or various components thereof, may be an example of means for performing various aspects of HARQ type configuration for sidelink and downlink communications as described herein. For example, the communications manager 720 may include a sidelink feedback mode manager 725, a sidelink manager 730, a sidelink feedback manager 735, a direct link feedback mode manager 740, a direct link manager 745, a direct link feedback manager 750, a default sidelink feedback mode manager 755, a resource block manager 760, a resource pool manager 765, a default direct link feedback mode manager 770, a DCI manager 775, an SPS manager 780, a component carrier manager 790, a broadcast signal manager 795, or any combination thereof. Each of these components may communicate, directly or indirectly, with one another (e.g., via one or more buses).

The communications manager 720 may support wireless communications at a first UE in accordance with examples as disclosed herein. The sidelink feedback mode manager 725 may be configured as or otherwise support a means for receiving control signaling indicating a feedback mode for a set of sidelink transmissions, where the feedback mode is independent of a cast type of the set of sidelink transmissions. The sidelink manager 730 may be configured as or otherwise support a means for receiving, from a second UE, the set of sidelink transmissions. The sidelink feedback manager 735 may be configured as or otherwise support a means for operating in the feedback mode for the set of sidelink transmissions in accordance with the control signaling.

In some examples, to support operating in the feedback mode, the sidelink feedback mode manager 725 may be configured as or otherwise support a means for operating in a HARQ mode, an ACK only mode, a NACK only mode, or a no feedback mode.

In some examples, the sidelink feedback mode manager 725 may be configured as or otherwise support a means for receiving the control signaling via an RRC message or a MAC-CE, where the set of sidelink transmissions are associated with a window of time.

In some examples, the direct link manager 745 may be configured as or otherwise support a means for receiving the control signaling from a base station.

In some examples, the default sidelink feedback mode manager 755 may be configured as or otherwise support a means for receiving second control signaling indicating a default feedback mode. In some examples, the sidelink feedback mode manager 725 may be configured as or otherwise support a means for receiving third control signaling in an RRC message or a MAC-CE indicating a second feedback mode associated with a window of time. In some examples, to receive the control signaling indicating the feedback mode for the set of sidelink transmissions, the sidelink feedback mode manager 725 may be configured as or otherwise support a means for receiving the control signaling including a bit indicating that the first UE is to use the default feedback mode or the second feedback mode.

In some examples, the broadcast signal manager 795 may be configured as or otherwise support a means for receiving the second control signaling via a MIB via a physical broadcast channel.

In some examples, the resource block manager 760 may be configured as or otherwise support a means for receiving second control signaling indicating a respective set of resource blocks associated with each feedback mode of a set of feedback modes.

In some examples, the sidelink manager 730 may be configured as or otherwise support a means for receiving the control signaling from the second UE via a sidelink control information message.

Additionally or alternatively, the communications manager 720 may support wireless communications at a second UE in accordance with examples as disclosed herein. In some examples, the sidelink feedback mode manager 725 may be configured as or otherwise support a means for transmitting, to a first UE, control signaling indicating a feedback mode for a set of sidelink transmissions, where the feedback mode is independent of a cast type of the set of sidelink transmissions. In some examples, the sidelink manager 730 may be configured as or otherwise support a means for transmitting, to the first UE, the set of sidelink transmissions. In some examples, the sidelink feedback manager 735 may be configured as or otherwise support a means for operating in the feedback mode for the set of sidelink transmissions.

In some examples, the sidelink feedback mode manager 725 may be configured as or otherwise support a means for receiving, from a base station, second control signaling indicating the feedback mode for the set of sidelink transmissions, where the control signaling is based on the second control signaling.

In some examples, to support operating in the feedback mode, the sidelink feedback manager 735 may be configured as or otherwise support a means for operating in a HARQ mode, an ACK only mode, a NACK only mode, or a no feedback mode.

In some examples, the sidelink manager 730 may be configured as or otherwise support a means for transmitting the control signaling via an RRC message or a MAC-CE, where the set of sidelink transmissions associated with a window of time.

In some examples, the default sidelink feedback mode manager 755 may be configured as or otherwise support a means for transmitting, to the first UE, second control signaling indicating a default feedback mode. In some examples, the sidelink feedback mode manager 725 may be configured as or otherwise support a means for transmitting, to the first UE, third control signaling in an RRC message or a MAC-CE indicating a second feedback mode associated with a window of time. In some examples, to transmit the control signaling indicating the feedback mode for the set of sidelink transmissions, the sidelink feedback mode manager 725 may be configured as or otherwise support a means for transmitting the control signaling including a bit indicating that the first UE is to use the default feedback mode or the second feedback mode.

In some examples, the broadcast signal manager 795 may be configured as or otherwise support a means for transmitting the second control signaling via a MIB via a physical broadcast channel.

In some examples, the default sidelink feedback mode manager 755 may be configured as or otherwise support a means for receiving, from a base station, fourth control signaling indicating the default feedback mode.

In some examples, the resource block manager 760 may be configured as or otherwise support a means for transmitting second control signaling indicating a respective set of resource blocks associated with each feedback mode of a set of feedback modes.

In some examples, the resource pool manager 765 may be configured as or otherwise support a means for receiving, from a base station, second control signaling indicating a set of feedback modes associated with each resource pool of a set of resource pools. In some examples, the sidelink feedback mode manager 725 may be configured as or otherwise support a means for identifying the feedback mode based on the set of feedback modes associated with a resource pool associated with the set of sidelink transmissions.

In some examples, identifying the feedback mode is based on the set of feedback modes associated with the resource pool associated with the set of sidelink transmissions based on a priority level or a quality of service target associated with the set of sidelink transmissions.

In some examples, the sidelink manager 730 may be configured as or otherwise support a means for transmitting the control signaling via a sidelink control information message.

Additionally or alternatively, the communications manager 720 may support wireless communications at a UE in accordance with examples as disclosed herein. The direct link feedback mode manager 740 may be configured as or otherwise support a means for receiving, from a base station, control signaling indicating a feedback mode for a set of downlink transmissions. The direct link manager 745 may be configured as or otherwise support a means for receiving, from the base station, the set of downlink transmissions. The direct link feedback manager 750 may be configured as or otherwise support a means for operating in the feedback mode for the set of downlink transmissions in accordance with the control signaling.

In some examples, the default direct link feedback mode manager 770 may be configured as or otherwise support a means for receiving, from the base station, second control signaling indicating a default feedback mode. In some examples, the direct link feedback mode manager 740 may be configured as or otherwise support a means for receiving third control signaling, from the base station, in an RRC message or a MAC-CE indicating a second feedback mode associated with a window of time. In some examples, to receive the control signaling indicating the feedback mode for the set of downlink transmissions, the default direct link feedback mode manager 770 may be configured as or otherwise support a means for receiving the control signaling including a bit indicating that the UE is to use the default feedback mode or the second feedback mode.

In some examples, the DCI manager 775 may be configured as or otherwise support a means for receiving the control signaling via a DCI message. In some examples, the direct link feedback manager 750 may be configured as or otherwise support a means for identifying the feedback mode based on a format of the DCI message, a payload of the DCI message, a search space associated with the DCI message, a control resource set associated with the DCI message, or a combination thereof.

In some examples, the SPS manager 780 may be configured as or otherwise support a means for receiving, from the base station, second control signaling indicating a set of feedback modes associated with each SPS index of a set of SPS indices. In some examples, the direct link feedback manager 750 may be configured as or otherwise support a means for identifying the feedback mode based on the set of feedback modes associated with a SPS index associated with the set of downlink transmissions.

In some examples, the component carrier manager 790 may be configured as or otherwise support a means for receiving, from the base station, second control signaling indicating a set of feedback modes associated with each component carrier of a set of component carriers. In some examples, the direct link feedback manager 750 may be configured as or otherwise support a means for identifying the feedback mode based on the set of feedback modes associated with a component carrier associated with the set of downlink transmissions.

In some examples, the default direct link feedback mode manager 770 may be configured as or otherwise support a means for receiving, from the base station, second control signaling indicating a default feedback mode. In some examples, the direct link feedback manager 750 may be configured as or otherwise support a means for operating in the default feedback mode for a second set of downlink transmissions after the set of downlink transmissions.

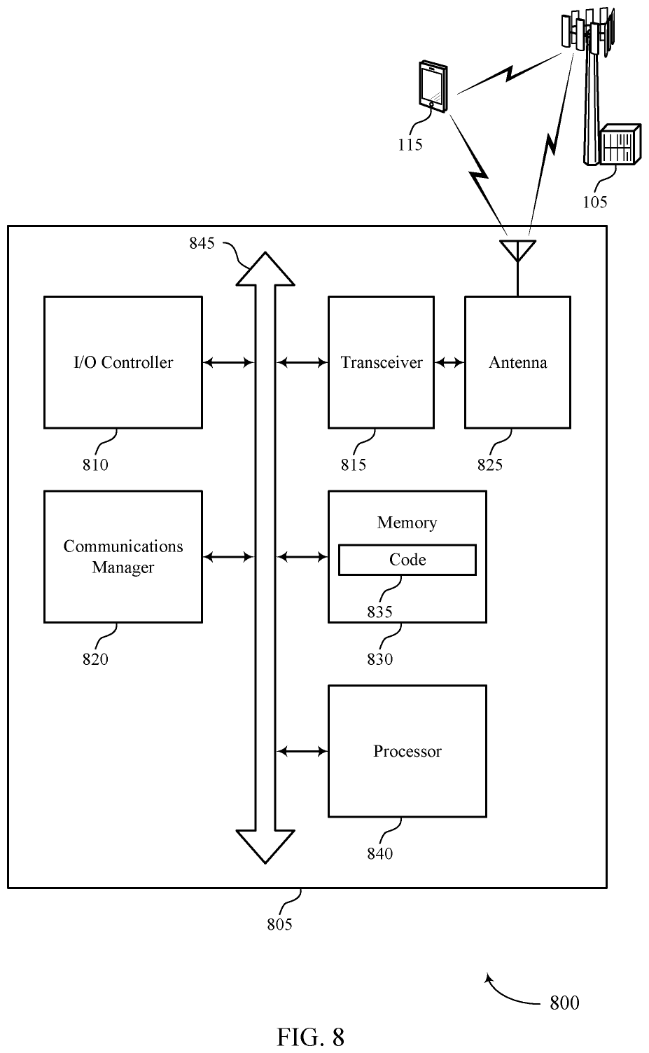

FIG. 8 shows a diagram of a system 800 including a device 805 that supports HARQ type configuration for sidelink and downlink communications in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting HARQ type configuration for sidelink and downlink communications). For example, the device 805 or a component of the device 805 may include a processor 840 and memory 830 coupled to the processor 840, the processor 840 and memory 830 configured to perform various functions described herein.

The communications manager 820 may support wireless communications at a first UE in accordance with examples as disclosed herein. For example, the communications manager 820 may be configured as or otherwise support a means for receiving control signaling indicating a feedback mode for a set of sidelink transmissions, where the feedback mode is independent of a cast type of the set of sidelink transmissions. The communications manager 820 may be configured as or otherwise support a means for receiving, from a second UE, the set of sidelink transmissions. The communications manager 820 may be configured as or otherwise support a means for operating in the feedback mode for the set of sidelink transmissions in accordance with the control signaling.

Additionally or alternatively, the communications manager 820 may support wireless communications at a second UE in accordance with examples as disclosed herein. For example, the communications manager 820 may be configured as or otherwise support a means for transmitting, to a first UE, control signaling indicating a feedback mode for a set of sidelink transmissions, where the feedback mode is independent of a cast type of the set of sidelink transmissions. The communications manager 820 may be configured as or otherwise support a means for transmitting, to the first UE, the set of sidelink transmissions. The communications manager 820 may be configured as or otherwise support a means for operating in the feedback mode for the set of sidelink transmissions.

Additionally or alternatively, the communications manager 820 may support wireless communications at a UE in accordance with examples as disclosed herein. For example, the communications manager 820 may be configured as or otherwise support a means for receiving, from a base station, control signaling indicating a feedback mode for a set of downlink transmissions. The communications manager 820 may be configured as or otherwise support a means for receiving, from the base station, the set of downlink transmissions. The communications manager 820 may be configured as or otherwise support a means for operating in the feedback mode for the set of downlink transmissions in accordance with the control signaling.

By including or configuring the communications manager 820 in accordance with examples as described herein, the device 805 may support techniques for improved communication reliability, reduced power consumption, more efficient utilization of communication resources, and improved coordination between devices by facilitating selection of an efficient feedback mode for given sidelink or downlink transmissions.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of HARQ type configuration for sidelink and downlink communications as described herein, or the processor 840 and the memory 830 may be otherwise configured to perform or support such operations.

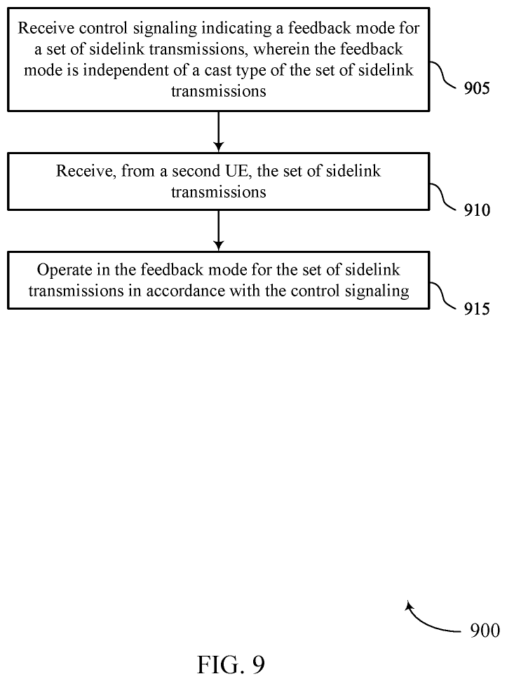

FIG. 9 shows a flowchart illustrating a method 900 that supports HARQ type configuration for sidelink and downlink communications in accordance with aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 905, the method may include receiving control signaling indicating a feedback mode for a set of sidelink transmissions, where the feedback mode is independent of a cast type of the set of sidelink transmissions. The operations of 905 may be performed in accordance with examples as disclosed herein. In some examples, aspects of the operations of 905 may be performed by a sidelink feedback mode manager 725 as described with reference to FIG. 7.

At 910, the method may include receiving, from a second UE, the set of sidelink transmissions. The operations of 910 may be performed in accordance with examples as disclosed herein. In some examples, aspects of the operations of 910 may be performed by a sidelink manager 730 as described with reference to FIG. 7.

At 915, the method may include operating in the feedback mode for the set of sidelink transmissions in accordance with the control signaling. The operations of 915 may be performed in accordance with examples as disclosed herein. In some examples, aspects of the operations of 915 may be performed by a sidelink feedback manager 735 as described with reference to FIG. 7.

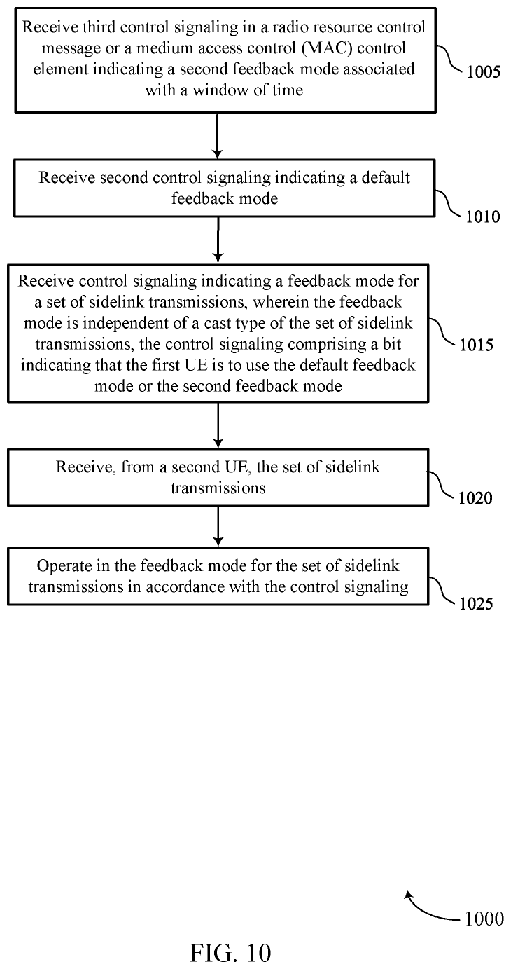

FIG. 10 shows a flowchart illustrating a method 1000 that supports HARQ type configuration for sidelink and downlink communications in accordance with aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1005, the method may include receiving third control signaling in an RRC message or a MAC-CE indicating a second feedback mode associated with a window of time. The operations of 1025 may be performed in accordance with examples as disclosed herein. In some examples, aspects of the operations of 1025 may be performed by a sidelink feedback mode manager 725 as described with reference to FIG. 7.

At 1010, the method may include receiving second control signaling indicating a default feedback mode. The operations of 1020 may be performed in accordance with examples as disclosed herein. In some examples, aspects of the operations of 1020 may be performed by a default sidelink feedback mode manager 755 as described with reference to FIG. 7.

At 1015, the method may include receiving control signaling indicating a feedback mode for a set of sidelink transmissions, where the feedback mode is independent of a cast type of the set of sidelink transmissions. In some examples, receiving the control signaling indicating the feedback mode for the set of sidelink transmissions may include receiving the control signaling including a bit indicating that the first UE is to use the default feedback mode or the second feedback mode. The operations of 1005 may be performed in accordance with examples as disclosed herein. In some examples, aspects of the operations of 1005 may be performed by a sidelink feedback mode manager 725 as described with reference to FIG. 7.

At 1020, the method may include receiving, from a second UE, the set of sidelink transmissions. The operations of 1010 may be performed in accordance with examples as disclosed herein. In some examples, aspects of the operations of 1010 may be performed by a sidelink manager 730 as described with reference to FIG. 7.

At 1025, the method may include operating in the feedback mode for the set of sidelink transmissions in accordance with the control signaling. The operations of 1015 may be performed in accordance with examples as disclosed herein. In some examples, aspects of the operations of 1015 may be performed by a sidelink feedback manager 735 as described with reference to FIG. 7.

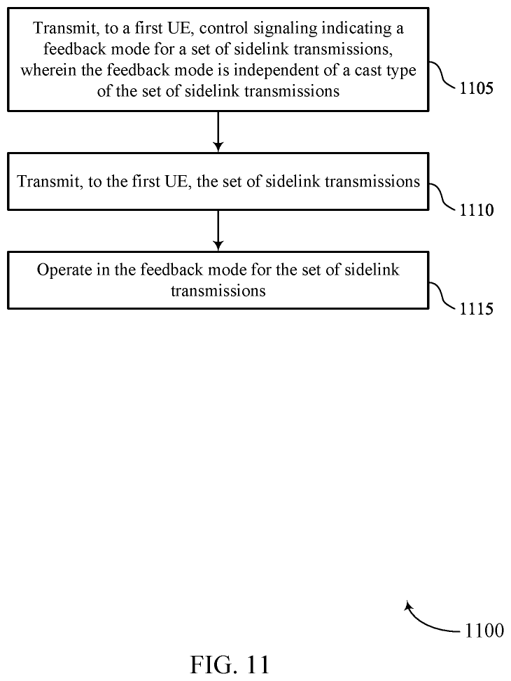

FIG. 11 shows a flowchart illustrating a method 1100 that supports HARQ type configuration for sidelink and downlink communications in accordance with aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1105, the method may include transmitting, to a first UE, control signaling indicating a feedback mode for a set of sidelink transmissions, where the feedback mode is independent of a cast type of the set of sidelink transmissions. The operations of 1105 may be performed in accordance with examples as disclosed herein. In some examples, aspects of the operations of 1105 may be performed by a sidelink feedback mode manager 725 as described with reference to FIG. 7.

At 1110, the method may include transmitting, to the first UE, the set of sidelink transmissions. The operations of 1110 may be performed in accordance with examples as disclosed herein. In some examples, aspects of the operations of 1110 may be performed by a sidelink manager 730 as described with reference to FIG. 7.

At 1115, the method may include operating in the feedback mode for the set of sidelink transmissions. The operations of 1115 may be performed in accordance with examples as disclosed herein. In some examples, aspects of the operations of 1115 may be performed by a sidelink feedback manager 735 as described with reference to FIG. 7.

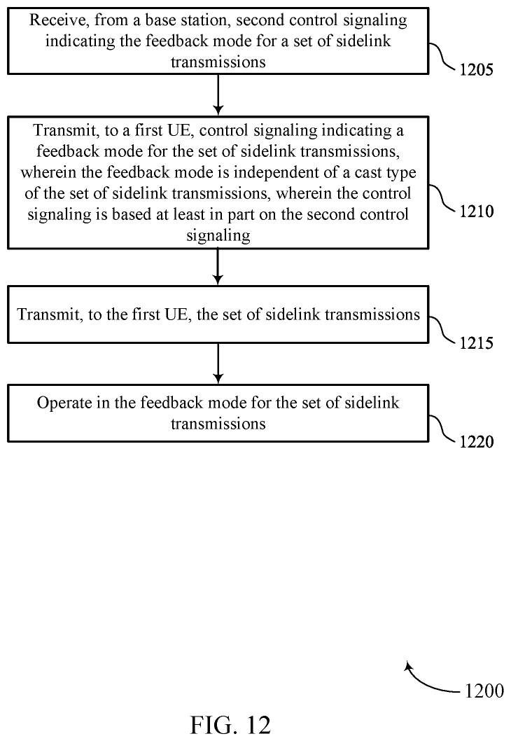

FIG. 12 shows a flowchart illustrating a method 1200 that supports HARQ type configuration for sidelink and downlink communications in accordance with aspects of the present disclosure. The operations of the method 1200 may be implemented by a UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1205, the method may include receiving, from a base station, second control signaling indicating the feedback mode for a set of sidelink transmissions, where the control signaling is based on the second control signaling. The operations of 1205 may be performed in accordance with examples as disclosed herein. In some examples, aspects of the operations of 1205 may be performed by a sidelink feedback mode manager 725 as described with reference to FIG. 7.

At 1210, the method may include transmitting, to a first UE, control signaling indicating a feedback mode for the set of sidelink transmissions, where the feedback mode is independent of a cast type of the set of sidelink transmissions. The operations of 1210 may be performed in accordance with examples as disclosed herein. In some examples, aspects of the operations of 1210 may be performed by a sidelink feedback mode manager 725 as described with reference to FIG. 7.

At 1215, the method may include transmitting, to the first UE, the set of sidelink transmissions. The operations of 1215 may be performed in accordance with examples as disclosed herein. In some examples, aspects of the operations of 1215 may be performed by a sidelink manager 730 as described with reference to FIG. 7.

At 1220, the method may include operating in the feedback mode for the set of sidelink transmissions. The operations of 1220 may be performed in accordance with examples as disclosed herein. In some examples, aspects of the operations of 1220 may be performed by a sidelink feedback manager 735 as described with reference to FIG. 7.

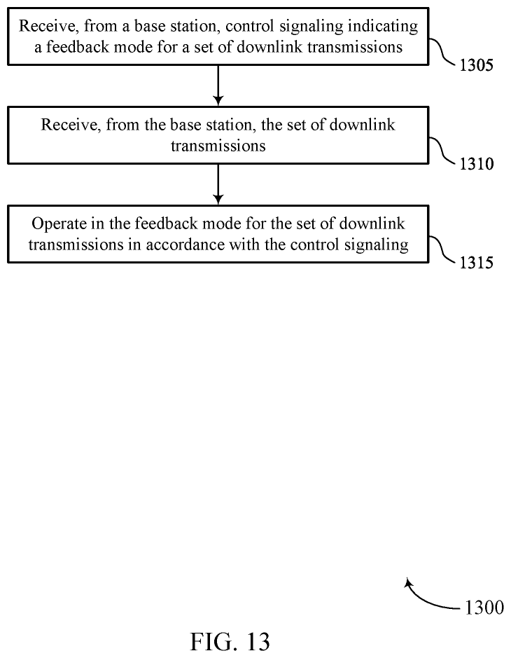

FIG. 13 shows a flowchart illustrating a method 1300 that supports HARQ type configuration for sidelink and downlink communications in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include receiving, from a base station, control signaling indicating a feedback mode for a set of downlink transmissions. The operations of 1305 may be performed in accordance with examples as disclosed herein. In some examples, aspects of the operations of 1305 may be performed by a direct link feedback mode manager 740 as described with reference to FIG. 7.

At 1310, the method may include receiving, from the base station, the set of downlink transmissions. The operations of 1310 may be performed in accordance with examples as disclosed herein. In some examples, aspects of the operations of 1310 may be performed by a direct link manager 745 as described with reference to FIG. 7.

At 1315, the method may include operating in the feedback mode for the set of downlink transmissions in accordance with the control signaling. The operations of 1315 may be performed in accordance with examples as disclosed herein. In some examples, aspects of the operations of 1315 may be performed by a direct link feedback manager 750 as described with reference to FIG. 7.

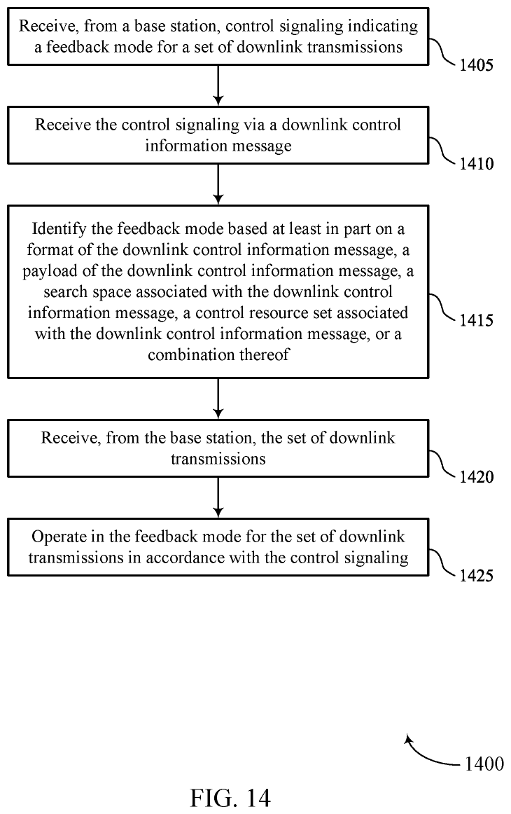

FIG. 14 shows a flowchart illustrating a method 1400 that supports HARQ type configuration for sidelink and downlink communications in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, control signaling indicating a feedback mode for a set of downlink transmissions. The operations of 1405 may be performed in accordance with examples as disclosed herein. In some examples, aspects of the operations of 1405 may be performed by a direct link feedback mode manager 740 as described with reference to FIG. 7.

At 1410, the method may include receiving the control signaling via a DCI message. The operations of 1410 may be performed in accordance with examples as disclosed herein. In some examples, aspects of the operations of 1410 may be performed by a DCI manager 775 as described with reference to FIG. 7.

At 1415, the method may include identifying the feedback mode based on a format of the DCI message, a payload of the DCI message, a search space associated with the DCI message, a control resource set associated with the DCI message, or a combination thereof. The operations of 1415 may be performed in accordance with examples as disclosed herein. In some examples, aspects of the operations of 1415 may be performed by a direct link feedback manager 750 as described with reference to FIG. 7.

At 1420, the method may include receiving, from the base station, the set of downlink transmissions. The operations of 1420 may be performed in accordance with examples as disclosed herein. In some examples, aspects of the operations of 1420 may be performed by a direct link manager 745 as described with reference to FIG. 7.

At 1425, the method may include operating in the feedback mode for the set of downlink transmissions in accordance with the control signaling. The operations of 1425 may be performed in accordance with examples as disclosed herein. In some examples, aspects of the operations of 1425 may be performed by a direct link feedback manager 750 as described with reference to FIG. 7.

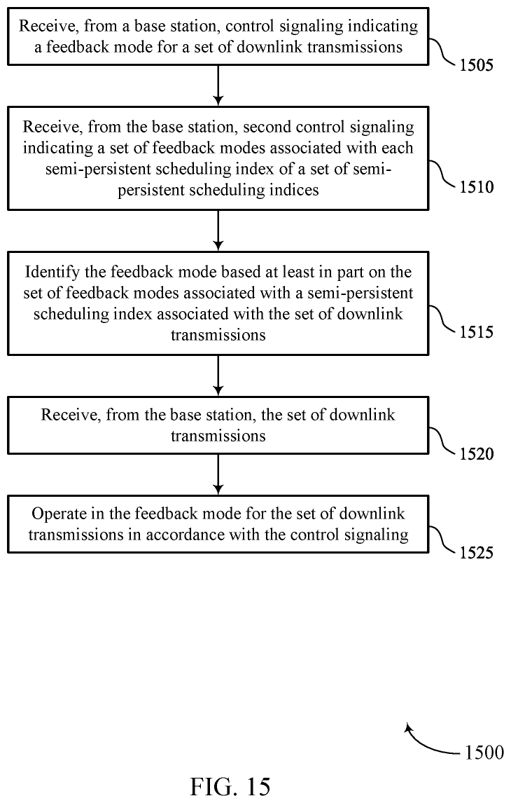

FIG. 15 shows a flowchart illustrating a method 1500 that supports HARQ type configuration for sidelink and downlink in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1505, the method may include receiving, from a base station, control signaling indicating a feedback mode for a set of downlink transmissions. The operations of 1505 may be performed in accordance with examples as disclosed herein. In some examples, aspects of the operations of 1505 may be performed by a direct link feedback mode manager 740 as described with reference to FIG. 7.

At 1510, the method may include receiving, from the base station, second control signaling indicating a set of feedback modes associated with each SPS index of a set of SPS indices. The operations of 1510 may be performed in accordance with examples as disclosed herein. In some examples, aspects of the operations of 1510 may be performed by an SPS manager 780 as described with reference to FIG. 7.

At 1515, the method may include identifying the feedback mode based on the set of feedback modes associated with a SPS index associated with the set of downlink transmissions. The operations of 1515 may be performed in accordance with examples as disclosed herein. In some examples, aspects of the operations of 1515 may be performed by the direct link feedback manager 750 as described with reference to FIG. 7.

At 1520, the method may include receiving, from the base station, the set of downlink transmissions. The operations of 1520 may be performed in accordance with examples as disclosed herein. In some examples, aspects of the operations of 1520 may be performed by a direct link manager 745 as described with reference to FIG. 7.

At 1525, the method may include operating in the feedback mode for the set of downlink transmissions in accordance with the control signaling. The operations of 1525 may be performed in accordance with examples as disclosed herein. In some examples, aspects of the operations of 1525 may be performed by a direct link feedback manager 750 as described with reference to FIG. 7.

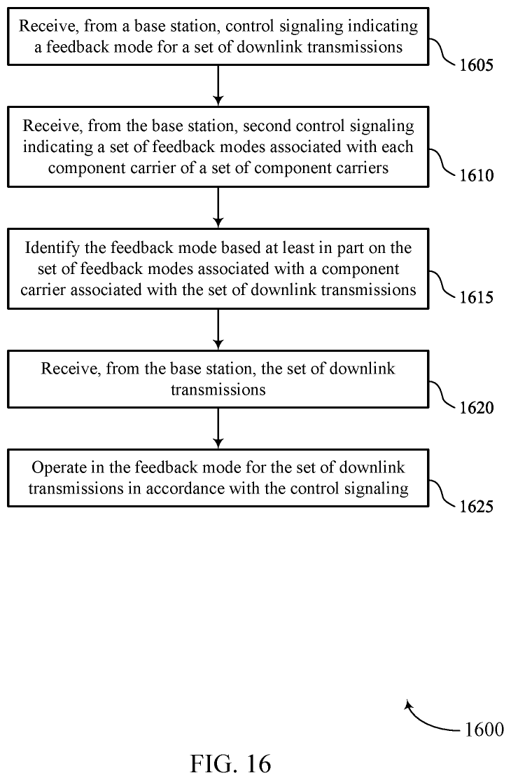

FIG. 16 shows a flowchart illustrating a method 1600 that supports HARQ type configuration for sidelink and downlink communications in accordance with aspects of the present disclosure. The operations of the method 1600 may be implemented by a UE or its components as described herein. For example, the operations of the method 1600 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1605, the method may include receiving, from a base station, control signaling indicating a feedback mode for a set of downlink transmissions. The operations of 1605 may be performed in accordance with examples as disclosed herein. In some examples, aspects of the operations of 1605 may be performed by a direct link feedback mode manager 740 as described with reference to FIG. 7.

At 1610, the method may include receiving, from the base station, second control signaling indicating a set of feedback modes associated with each component carrier of a set of component carriers. The operations of 1610 may be performed in accordance with examples as disclosed herein. In some examples, aspects of the operations of 1610 may be performed by a component carrier manager 790 as described with reference to FIG. 7.

At 1615, the method may include identifying the feedback mode based at least in part on the set of feedback modes associated with a component carrier associated with the set of downlink transmissions. The operations of 1615 may be performed in accordance with examples as disclosed herein. In some examples, aspects of the operations of 1615 may be performed by a direct link feedback manager 750 as described with reference to FIG. 7.

At 1620, the method may include receiving, from the base station, the set of downlink transmissions. The operations of 1620 may be performed in accordance with examples as disclosed herein. In some examples, aspects of the operations of 1620 may be performed by a direct link manager 745 as described with reference to FIG. 7.

At 1625, the method may include operating in the feedback mode for the set of downlink transmissions in accordance with the control signaling. The operations of 1625 may be performed in accordance with examples as disclosed herein. In some examples, aspects of the operations of 1625 may be performed by a direct link feedback manager 750 as described with reference to FIG. 7.

The following provides an overview of aspects of the present disclosure:

Aspect 1: A method for wireless communications at a first UE, comprising: receiving control signaling indicating a feedback mode for a set of sidelink transmissions, wherein the feedback mode is independent of a cast type of the set of sidelink transmissions; receiving, from a second UE, the set of sidelink transmissions; and operating in the feedback mode for the set of sidelink transmissions in accordance with the control signaling.

Aspect 2: The method of aspect 1, wherein operating in the feedback mode comprises: operating in a HARQ mode, an ACK only mode, a NACK only mode, or a no feedback mode.

Aspect 3: The method of any of aspects 1 through 2, further comprising: receiving the control signaling via an RRC message or a MAC-CE, wherein the set of sidelink transmissions are associated with a window of time.

Aspect 4: The method of aspect 3, further comprising: receiving the control signaling from a base station.

Aspect 5: The method of any of aspects 1 through 4, further comprising: receiving second control signaling indicating a default feedback mode; and receiving third control signaling in an RRC message or a MAC-CE indicating a second feedback mode associated with a window of time, and wherein receiving the control signaling indicating the feedback mode for the set of sidelink transmissions comprises: receiving the control signaling comprising a bit indicating that the first UE is to use the default feedback mode or the second feedback mode.

Aspect 6: The method of aspect 5, further comprising: receiving the second control signaling via a master information block via a physical broadcast channel.

Aspect 7: The method of any of aspects 1 through 6, further comprising: receiving second control signaling indicating a respective set of resource blocks associated with each feedback mode of a set of feedback modes.

Aspect 8: The method of any of aspects 1 through 7, further comprising: receiving the control signaling from the second UE via a sidelink control information message.

Aspect 9: A method for wireless communications at a second UE, comprising: transmitting, to a first UE, control signaling indicating a feedback mode for a set of sidelink transmissions, wherein the feedback mode is independent of a cast type of the set of sidelink transmissions; transmitting, to the first UE, the set of sidelink transmissions; and operating in the feedback mode for the set of sidelink transmissions.

Aspect 10: The method of aspect 9, further comprising: receiving, from a base station, second control signaling indicating the feedback mode for the set of sidelink transmissions, wherein the control signaling is based at least in part on the second control signaling.

Aspect 11: The method of any of aspects 9 through 10, wherein operating in the feedback mode comprises: operating in a HARQ mode, an ACK only mode, a NACK only mode, or a no feedback mode.

Aspect 12: The method of any of aspects 9 through 11, further comprising: transmitting the control signaling via an RRC message or a MAC-CE, wherein the set of sidelink transmissions associated with a window of time.

Aspect 13: The method of any of aspects 9 through 12, further comprising: transmitting, to the first UE, second control signaling indicating a default feedback mode; and transmitting, to the first UE, third control signaling in an RRC message or a MAC-CE indicating a second feedback mode associated with a window of time, and wherein transmitting the control signaling indicating the feedback mode for the set of sidelink transmissions comprises: transmitting the control signaling comprising a bit indicating that the first UE is to use the default feedback mode or the second feedback mode.

Aspect 14: The method of aspect 13, further comprising: transmitting the second control signaling via a master information block via a physical broadcast channel.

Aspect 15: The method of any of aspects 13 through 14, further comprising: receiving, from a base station, fourth control signaling indicating the default feedback mode.

Aspect 16: The method of any of aspects 9 through 15, further comprising: transmitting second control signaling indicating a respective set of resource blocks associated with each feedback mode of a set of feedback modes.

Aspect 17: The method of any of aspects 9 through 16, further comprising: receiving, from a base station, second control signaling indicating a set of feedback modes associated with each resource pool of a set of resource pools; and identifying the feedback mode based at least in part on the set of feedback modes associated with a resource pool associated with the set of sidelink transmissions.

Aspect 18: The method of aspect 17, wherein identifying the feedback mode is based at least in part on the set of feedback modes associated with the resource pool associated with the set of sidelink transmissions based at least in part on a priority level or a quality of service target associated with the set of sidelink transmissions.

Aspect 19: The method of any of aspects 9 through 18, further comprising: transmitting the control signaling via a sidelink control information message.

Aspect 20: A method for wireless communications at a UE, comprising: receiving, from a base station, control signaling indicating a feedback mode for a set of downlink transmissions; receiving, from the base station, the set of downlink transmissions; and operating in the feedback mode for the set of downlink transmissions in accordance with the control signaling.

Aspect 21: The method of aspect 20, further comprising: receiving, from the base station, second control signaling indicating a default feedback mode; receiving third control signaling, from the base station, in an RRC message or a MAC-CE indicating a second feedback mode associated with a window of time, and wherein receiving the control signaling indicating the feedback mode for the set of downlink transmissions comprises: receiving the control signaling comprising a bit indicating that the UE is to use the default feedback mode or the second feedback mode.

Aspect 22: The method of any of aspects 20 through 21, further comprising: receiving the control signaling via a DCI message; and identifying the feedback mode based at least in part on a format of the DCI message, a payload of the DCI message, a search space associated with the DCI message, a control resource set associated with the DCI message, or a combination thereof.

Aspect 23: The method of any of aspects 20 through 22, further comprising: receiving, from the base station, second control signaling indicating a set of feedback modes associated with each semi-persistent scheduling index of a set of semi-persistent scheduling indices; and identifying the feedback mode based at least in part on the set of feedback modes associated with a semi-persistent scheduling index associated with the set of downlink transmissions.

Aspect 24: The method of any of aspects 20 through 23, further comprising: receiving, from the base station, second control signaling indicating a set of feedback modes associated with each component carrier of a set of component carriers; and identifying the feedback mode based at least in part on the set of feedback modes associated with a component carrier associated with the set of downlink transmissions.

Aspect 25: The method of any of aspects 20 through 24, further comprising: receiving, from the base station, second control signaling indicating a default feedback mode; and operating in the default feedback mode for a second set of downlink transmissions after the set of downlink transmissions.

Aspect 26: An apparatus for wireless communications at a first UE, comprising a processor; memory coupled with the processor; and instructions stored in the memory and executable by the processor to cause the apparatus to perform a method of any of aspects 1 through 8.

Aspect 27: An apparatus for wireless communications at a first UE, comprising at least one means for performing a method of any of aspects 1 through 8.

Aspect 28: A non-transitory computer-readable medium storing code for wireless communications at a first UE, the code comprising instructions executable by a processor to perform a method of any of aspects 1 through 8.

Aspect 29: An apparatus for wireless communications at a second UE, comprising a processor; memory coupled with the processor; and instructions stored in the memory and executable by the processor to cause the apparatus to perform a method of any of aspects 9 through 19.

Aspect 30: An apparatus for wireless communications at a second UE, comprising at least one means for performing a method of any of aspects 9 through 19.

Aspect 31: A non-transitory computer-readable medium storing code for wireless communications at a second UE, the code comprising instructions executable by a processor to perform a method of any of aspects 9 through 19.

Aspect 32: An apparatus for wireless communications at a UE, comprising a processor; memory coupled with the processor; and instructions stored in the memory and executable by the processor to cause the apparatus to perform a method of any of aspects 20 through 25.

Aspect 33: An apparatus for wireless communications at a UE, comprising at least one means for performing a method of any of aspects 20 through 25.

Aspect 34: A non-transitory computer-readable medium storing code for wireless communications at a UE, the code comprising instructions executable by a processor to perform a method of any of aspects 20 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or (A or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), or ascertaining. Also, “determining” can include receiving (such as receiving information) or accessing (such as accessing data in a memory). Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a first user equipment (UE), comprising:
receiving control signaling indicating a feedback mode for a set of sidelink transmissions, wherein the feedback mode is independent of a cast type of the set of sidelink transmissions;
receiving, from a second UE, the set of sidelink transmissions; and
operating in the feedback mode for the set of sidelink transmissions in accordance with the control signaling.

2. The method of claim 1, wherein operating in the feedback mode comprises:
operating in a hybrid automatic repeat request mode, an acknowledgement only mode, a negative acknowledgement only mode, or a no feedback mode.

3. The method of claim 1, further comprising:
receiving the control signaling via a radio resource control message or a medium access control (MAC) control element, wherein the set of sidelink transmissions are associated with a window of time.

4. The method of claim 3, further comprising:
receiving the control signaling from a base station.

5. The method of claim 1, further comprising:
receiving second control signaling indicating a default feedback mode; and
receiving third control signaling in a radio resource control message or a medium access control (MAC) control element indicating a second feedback mode associated with a window of time, and wherein receiving the control signaling indicating the feedback mode for the set of sidelink transmissions comprises:
receiving the control signaling comprising a bit indicating that the first UE is to use the default feedback mode or the second feedback mode.

6. The method of claim 5, further comprising:
receiving the second control signaling via a master information block via a physical broadcast channel.

7. The method of claim 1, further comprising:
receiving second control signaling indicating a respective set of resource blocks associated with each feedback mode of a set of feedback modes.

8. The method of claim 1, further comprising:
receiving the control signaling from the second UE via a sidelink control information message.

9. A method for wireless communications at a second user equipment (UE), comprising:
transmitting, to a first UE, control signaling indicating a feedback mode for a set of sidelink transmissions, wherein the feedback mode is independent of a cast type of the set of sidelink transmissions;
transmitting, to the first UE, the set of sidelink transmissions; and
operating in the feedback mode for the set of sidelink transmissions.

10. The method of claim 9, further comprising:
receiving, from a base station, second control signaling indicating the feedback mode for the set of sidelink transmissions, wherein the control signaling is based at least in part on the second control signaling.

11. The method of claim 9, wherein operating in the feedback mode comprises:
operating in a hybrid automatic repeat request mode, an acknowledgement only mode, a negative acknowledgement only mode, or a no feedback mode.

12. The method of claim 9, further comprising:
transmitting the control signaling via a radio resource control message or a medium access control (MAC) control element, wherein the set of sidelink transmissions associated with a window of time.

13. The method of claim 9, further comprising:
transmitting, to the first UE, second control signaling indicating a default feedback mode; and
transmitting, to the first UE, third control signaling in a radio resource control message or a medium access control (MAC) control element indicating a second feedback mode associated with a window of time, and wherein transmitting the control signaling indicating the feedback mode for the set of sidelink transmissions comprises:
transmitting the control signaling comprising a bit indicating that the first UE is to use the default feedback mode or the second feedback mode.

14. The method of claim 13, further comprising:
transmitting the second control signaling via a master information block via a physical broadcast channel.

15. The method of claim 13, further comprising:
receiving, from a base station, fourth control signaling indicating the default feedback mode.

16. The method of claim 9, further comprising:
transmitting second control signaling indicating a respective set of resource blocks associated with each feedback mode of a set of feedback modes.

17. The method of claim 9, further comprising:
receiving, from a base station, second control signaling indicating a set of feedback modes associated with each resource pool of a set of resource pools; and
identifying the feedback mode based at least in part on the set of feedback modes associated with a resource pool associated with the set of sidelink transmissions.

18. The method of claim 17, wherein identifying the feedback mode is based at least in part on the set of feedback modes associated with the resource pool associated with the set of sidelink transmissions based at least in part on a priority level or a quality of service target associated with the set of sidelink transmissions.

19. The method of claim 9, further comprising:
transmitting the control signaling via a sidelink control information message.

20. A method for wireless communications at a user equipment (UE), comprising:
receiving, from a base station, control signaling indicating a feedback mode for a set of downlink transmissions;
receiving, from the base station, the set of downlink transmissions; and
operating in the feedback mode for the set of downlink transmissions in accordance with the control signaling.

21. The method of claim 20, further comprising:
receiving, from the base station, second control signaling indicating a default feedback mode;
receiving third control signaling, from the base station, in a radio resource control message or a medium access control (MAC) control element indicating a second feedback mode associated with a window of time, and wherein receiving the control signaling indicating the feedback mode for the set of downlink transmissions comprises:
receiving the control signaling comprising a bit indicating that the UE is to use the default feedback mode or the second feedback mode.

22. The method of claim 20, further comprising:
receiving the control signaling via a downlink control information message; and
identifying the feedback mode based at least in part on a format of the downlink control information message, a payload of the downlink control information message, a search space associated with the downlink control information message, a control resource set associated with the downlink control information message, or a combination thereof.

23. The method of claim 20, further comprising:
receiving, from the base station, second control signaling indicating a set of feedback modes associated with each semi-persistent scheduling index of a set of semi-persistent scheduling indices; and
identifying the feedback mode based at least in part on the set of feedback modes associated with a semi-persistent scheduling index associated with the set of downlink transmissions.

24. The method of claim 20, further comprising:
receiving, from the base station, second control signaling indicating a set of feedback modes associated with each component carrier of a set of component carriers; and
identifying the feedback mode based at least in part on the set of feedback modes associated with a component carrier associated with the set of downlink transmissions.

25. The method of claim 20, further comprising:
receiving, from the base station, second control signaling indicating a default feedback mode; and
operating in the default feedback mode for a second set of downlink transmissions after the set of downlink transmissions.

26. An apparatus for wireless communications at a first user equipment (UE), comprising:
at least one processor; and
memory coupled to the at least one processor, the memory storing instructions executable by the at least one processor to cause the apparatus to:
receive control signaling indicating a feedback mode for a set of sidelink transmissions, wherein the feedback mode is independent of a cast type of the set of sidelink transmissions;
receive, from a second UE, the set of sidelink transmissions; and
operate in the feedback mode for the set of sidelink transmissions in accordance with the control signaling.

27. The apparatus of claim 26, wherein the instructions to operate in the feedback mode are executable by the at least one processor to cause the apparatus to:
operate in a hybrid automatic repeat request mode, an acknowledgement only mode, a negative acknowledgement only mode, or a no feedback mode.

28. The apparatus of claim 26, wherein the instructions are further executable by the at least one processor to cause the apparatus to:
receive the control signaling via a radio resource control message or a medium access control (MAC) control element, wherein the set of sidelink transmissions are associated with a window of time.

29. The apparatus of claim 28, wherein the instructions are further executable by the at least one processor to cause the apparatus to:
receive the control signaling from a base station.

30. The apparatus of claim 26, wherein the instructions are further executable by the at least one processor to cause the apparatus to:
receive second control signaling indicating a default feedback mode; and
receive third control signaling in a radio resource control message or a medium access control (MAC) control element indicating a second feedback mode associated with a window of time, and wherein the instructions to receive the control signaling indicating the feedback mode for the set of sidelink transmissions are executable by the processor to cause the apparatus to:
receive the control signaling comprising a bit indicating that the first UE is to use the default feedback mode or the second feedback mode.
